(19) United States
(12) Patent Application Publication
(10) Pub. No.: US 2026/0347270 A1
(43) Pub. Date: Nov. 5, 2026

(54) Methods and Systems for Phosphoric Acid and Ammonium Salt Production

(71) Applicant: Travertine Technologies, Inc., Boulder, CO (US)

(72) Inventor: Laura N. Lammers, Boulder, CO (US)

(21) Appl. No.: 19/100,054

(22) PCT Filed: Feb. 1, 2024
(86) PCT No.: PCT/US2024/014029

§ 371 Date: Jan. 30, 2025

Related U.S. Application Data
(60) Provisional application No. 63/443,271, filed on Feb. 3, 2023.

(51) Int. Cl. C05B 7/00; C01C 1/04; C01F 11/46; C25B 1/02; C25B 15/08

(52) U.S. Cl. CPC C05B 7/00; C01C 1/0405; C01F 11/46; C25B 1/02; C25B 15/081

(57) ABSTRACT

Carbon-negative fertilizers and methods for making and using the same are provided. Aspects of the methods include reacting rock phosphorus with sulfuric acid (H₂SO₄) to produce phosphoric acid (H₃PO₄) and phosphogypsum (CaSO₄·2H₂O); converting the phosphogypsum to a calcium carbonate-containing solid product and thereby generating an aqueous sulfate; electrolyzing the aqueous sulfate to produce hydrogen (H₂); synthesizing ammonia (NH₃) from the hydrogen; and producing an ammonium salt from the ammonia. Also provided are systems for practicing the methods, as well as fertilizers produced by the methods.

### CROSS-REFERENCE TO RELATED APPLICATION

This application claims priority to U.S. Provisional Patent Application Ser. No. 63/443,271 filed Feb. 3, 2023, the disclosure of which application is incorporated herein by reference.

### INTRODUCTION

Global anthropogenic carbon dioxide (CO₂) emissions are approximately 50 gigatons per year, and affordable solutions to durably sequester CO₂ are needed to prevent catastrophic climate change (Mac Dowell et al., 2017; Sullivan et al., 2021). Recent IPCC projections indicate that around 6 billion metric tons (Gt) per year of direct air capture of CO₂ with durable storage (DACS) are required to reduce atmospheric CO₂ concentrations to levels that safely limit global warming (Riahi et al., 2022). Formation of carbonate minerals represents a safe, stable, and geologically permanent way to remove and sequester carbon dioxide (Lal, 2008; Mac Dowell et al., 2022), but mineral carbon sequestration requires both a source of carbon dioxide reactive elements (e.g., calcium and magnesium) and a permanent sink for acidity (i.e., an alkaline material such as rock phosphorus or ultramafic mine tailings). Achieving cost-effective carbon dioxide reduction (CDR) that can be scaled to gigatons per year of CO₂ sequestration poses a major technological challenge. Direct air capture of CO₂ is energy intensive, and many leading direct air capture technologies require several gigajoules of energy—often as heat—to sequester one ton of CO₂ (Zeman, 2007; Osman et al., 2021). Production of valuable co-products, such as cement products (Rau et al., 2013; Rau et al., 2018; La Plante et al., 2021), or coupling carbon removal with existing extractive processes (Lu et al., 2022) can help improve the economic viability of CDR.

Large-scale production of nutrient nitrogen, phosphorus, and potassium is necessary to feed the global population. However, conventional fertilizer production is highly carbon intensive. Production of ammonia for nitrogen fertilizers is one of the largest industrial sources of greenhouse gasses. Ammonia is conventionally produced by the Haber-Bosch process using hydrogen generated from steam methane reforming, which currently contributes around 450 million metric tons of CO₂ per year, or around 1% of the world's carbon dioxide emissions (Liu, 2014). The process also consumes more than 1% of the world's energy (Liu, 2014; Kyriakou et al., 2020). One ton of ammonia generates approximately 2 tons of carbon dioxide emissions (Ghavam et al., 2021). Green hydrogen can be used in place of methane-derived hydrogen to reduce the emissions associated with Haber-Bosch, but the process is not yet economically viable given the low cost of conventional ammonia and the relatively high cost of green hydrogen production.

Rock phosphorus represents a major geological alkalinity source that has been largely overlooked for mineral carbon sequestration. Conventional phosphate fertilizer production from rock phosphorus (mainly Ca₅(PO₄)₃X, where X is OH⁻, F⁻, and/or Cl⁻) requires large amounts of sulfuric acid and emits carbon dioxide to the atmosphere. Wet phosphoric acid (WPA) is conventionally produced by reacting rock phosphorus with sulfuric acid, recycled phosphoric acid, and water (Davenport et al., 1965). Most sulfuric acid for P fertilizer is produced by burning—or oxidizing—elemental sulfur derived from fossil fuel refining. Production of phosphoric acid (H₃PO₄) for fertilizer consumes around 60% of the global sulfuric acid supply and generates 200-300 Mt of waste gypsum (i.e., phosphogypsum, or PG) annually (King & Moates, 2013). Rock phosphorus processing neutralizes sulfuric acid to produce a weak acid, phosphoric acid, by the reaction using fluorapatite as an example,

Ca₅(PO₄)₃F(s, fluorapatite)+5H₂SO₄(aq)+10H₂O(I)→3H₃PO₄(aq)+5CaSO₄·2H₂O(s, gypsum)+HF(aq).

In alkaline solutions containing a strong base such as NaOH, the produced solid PG byproduct can be readily converted into carbonate minerals (cf. Fernández-Díaz et al., 2009), as follows:

CaSO₄·2H₂O(s, gypsum)+2NaOH(aq)+Co₂(g)→CaCO₃(s)+Na₂SO₄(aq)+3H₂O(I).

Phosphogypsum can be produced in several forms, as dihydrate (gypsum, CaSO₄·2H₂O), hemihydrate (CaSO₄·0.5H₂O), or anhydrite (CaSO₄), depending on the temperature and water concentration of the phosphoric acid reactor. Rock phosphate is often contaminated with other mineral phases including carbonates and silicates, so phosphoric acid production can release significant quantities of carbon dioxide due to the reaction between sulfuric acid and carbonate impurities. If CO₂ can be mineralized on an equimolar basis with phosphoric acid production from rock phosphorus, the acid neutralizing potential realized during phosphate fertilizer production can theoretically sequester 50-75 Mt/y carbon dioxide today.

### SUMMARY

Given the large environmental burden of conventional fertilizer production processes, the inventors have identified a pressing need to develop more sustainable approaches. To that end, described herein is a novel approach for producing several of the world's most common fertilizers, including phosphoric acid, monoammonium phosphate, diammonium phosphate, and ammonium sulfate, in a way that is significantly net negative with respect to carbon dioxide emissions and that also eliminates the production of phosphogypsum waste. In embodiments of the invention, ammonia and phosphoric acid are combined and crystallized to produce the world's most-used phosphate fertilizers: monoammonium phosphate (MAP) and diammonium phosphate (DAP). Ammonium sulfate is a less-used fertilizer but can be produced from phosphogypsum waste in a way that permanently sequesters carbon dioxide. The inventors have realized that conventional production of phosphoric acid, monoammonium phosphate, diammonium phosphate, and ammonium sulfate fertilizers result in an unacceptable level of CO₂ greenhouse gas emissions and in some cases large quantities of phosphogypsum waste. As such, an improved process for fertilizer production is desirable. The methods and systems of the invention satisfy this desire.

Aspects of the invention include methods of phosphoric acid and/or ammonium salt production. Methods of interest include reacting rock phosphorus with sulfuric acid (H₂SO₄) to produce phosphoric acid (H₃PO₄) and phosphogypsum (CaSO₄·2H₂O), and converting the phosphogypsum to a calcium-containing solid product and thereby generating an aqueous sulfate. Methods may additionally include electrolyzing the aqueous sulfate to produce hydrogen (H₂), synthesizing ammonia (NH₃) from the hydrogen, and producing an ammonium salt from the ammonia. The rock phosphorus reacted with the sulfuric acid may include, for example fluorapatite and/or hydroxyapatite. In some cases, the ammonium salt produced by the subject methods is an ammonium phosphate. In some such cases, the ammonium phosphate is monoammonium phosphate (MAP) and/or diammonium phosphate (DAP). Where the ammonium salt is an ammonium sulfate, methods of the invention may include producing the ammonium sulfate from the ammonia and the sulfuric acid. Methods of the invention may include processing the ammonium sulfate salt to recover concentrated sulfuric acid and ammonia gas, which can be recycled back into the process. In other cases, the ammonium salt is ammonium phosphate ((NH₄)₃PO₄). Methods of the invention may also include producing a fertilizer from the ammonium salt (e.g., MAP, DAP, ammonium sulfate). The calcium containing solid product produced in the subject methods may also vary, and can include, for example, precipitated calcium carbonate (PCC) and/or a slaked lime (Ca(OH)₂) alkaline solid product. In certain versions where PCC is produced, methods may include calcining the PCC or slaked lime to produce lime (CaO) and making a hydraulic cement from the lime. In some cases, methods include producing a concrete using the hydraulic cement. In select cases, synthesizing the ammonia comprises reacting the hydrogen with nitrogen gas (N₂).

In select versions, the ammonium salt is a carbon-negative ammonium salt. In some such versions, methods of the invention include a CO₂ sequestering protocol. Such protocols may include sequestering gaseous CO₂ from, for example, a point source (e.g., a flue gas) or from the air via direct air capture (DAC). In certain instances, the CO₂ sequestering protocol comprises reacting gaseous CO₂ with a base to produce an aqueous carbonate. In some cases, the method comprises reacting the aqueous carbonate with the phosphogypsum to produce the calcium-containing solid product. The amount of CO₂ sequestered may vary, and in some cases includes 0.6 tons of CO₂ per ton of ammonium salt produced.

Protocols for electrolyzing the aqueous sulfate can vary. In some cases, electrolytic protocols include producing an acidic solution and/or a basic solution. In some cases, the acidic solution comprises sulfuric acid. In some such cases, methods may include reacting the rock phosphorus with the dilute sulfuric acid solution obtained from electrolyzing the aqueous sulfate to produce the phosphoric acid and phosphogypsum. In additional embodiments, the H₂SO₄ may be used to produce wet phosphoric acid (WPA) from rock phosphorus, followed by reaction of WPA with ammonia to produce MAP or MAP and DAP. In some embodiments, methods include concentrating the sulfuric acid obtained from electrolyzing the aqueous sulfate prior to reacting it with the rock phosphorus (e.g., at concentrations ranging from 5 wt. % to 98 wt. %). Where the ammonium salt produced by the disclosed methods is ammonium sulfate, methods according to some embodiments include producing the ammonium sulfate from the ammonia and the sulfuric acid obtained from electrolyzing the aqueous sulfate. For example, the H₂SO₄ may be used to produce ammonium sulfate by reaction with ammonia followed by evaporative concentration and crystallization. Neutralization of sulfuric acid with ammonia during electrolysis improves the current efficiency of aqueous sulfate electrolysis from ~30-75% to greater than 90%. Embodiments of the method involve thermal decomposition of ammonium sulfate salt to ammonia and concentrated sulfuric acid ranging from 95 wt. % to 100 wt. % or sulfuric acid with excess SO₃ (oleum, >100 wt. % sulfuric acid). In some embodiments, ammonia can be recycled back or looped to continue producing ammonium sulfate in the aqueous sulfate electrolyzer.

In some cases, electrolyzing the aqueous sulfate includes producing gaseous oxygen (O₂) and producing gaseous hydrogen (H₂). In certain embodiments, the electrolyzing comprises the use of a membrane separating an anode chamber comprising an anolyte and a cathode chamber comprising a catholyte. In some such embodiments, the methods involve the use of an electrochemical salt splitting system such as an anion exchange membrane separated two-chamber cell system, a cation exchange membrane separated two-chamber cell system, a three-chamber cell system containing both an anion exchange membrane and a cation exchange membrane, or a bipolar membrane electrodialysis system comprising a stack of cells with an anion exchange membrane, a cation exchange membrane, and a bipolar membrane. In certain cases, the anion exchange membrane is configured so that sulfate anions cross an anion exchange membrane to the chamber where sulfuric acid is generated. Select embodiments of the methods also include maintaining a concentration of base in the catholyte or the center chamber that is low relative to the concentration of acid in the anolyte or the acid chamber, and recirculating fluid through the cathode chamber and the center chamber when present.

Aspects of the invention also include systems. Systems of the invention include a reactor configured to react rock phosphorus with sulfuric acid (H₂SO₄) and recycled phosphoric acid to produce phosphoric acid (H₃PO₄) and phosphogypsum (CaSO₄·2H₂O), a precipitator configured to convert the phosphogypsum to a calcium-containing solid product and thereby generate an aqueous sulfate, and an electrolysis unit configured to electrolyze the aqueous sulfate to produce hydrogen (H₂). Systems may additionally include an ammonia synthesizer configured to synthesize ammonia (NH₃) using the hydrogen, and an ammonium phosphate generator configured to produce an ammonium salt from the ammonia.

In embodiments, systems of the invention include an electrolyzer stack of one or more salt splitting electrochemical cells comprising a two-chamber anion exchange membrane separated cell, a two-chamber cation exchange membrane separated cell, a three-chamber cell containing both an anion exchange membrane and a cation exchange membrane, or a bipolar membrane electrodialysis cell comprising anion exchange membranes, cation exchange membranes, and bipolar membranes. In certain versions of the invention, the precipitator is operably connected to a source of sulfate (e.g., calcium sulfate). In some cases, the produced phosphogypsum may be operably connected to the precipitator as the source of calcium sulfate. In some cases, the ammonium salt generator is a crystallization reactor configured to receive ammonia and aqueous sulfuric acid or phosphoric acid to produce MAP, MAP and DAP, or ammonium sulfate. Embodiments of the subject systems may also include a hydrogen recovery module configured to receive hydrogen from the electrolyzer stack. In some cases, the produced hydrogen may be used to produce green ammonia. In some cases, the system is configured as a continuous flow system.

Also described herein are products of the invention. For example, aspects of the invention include an ammonium salt produced according to the subject methods, a hydraulic cement produced according to the subject methods, a concrete produced according to the subject methods, and/or a built structure produced from such a hydraulic cement according.

### BRIEF DESCRIPTION OF THE FIGURES

The invention may be best understood from the following detailed description when read in conjunction with the accompanying drawings. Included in the drawings are the following figures:

FIGS. 1A-1C present flowcharts for producing phosphoric acid and/or ammonium salt according to certain embodiments.

FIGS. 2A-2G present schematic flow diagrams of systems configured to produce phosphoric acid and/or ammonium salt according to certain embodiments.

FIGS. 3A-3B present electrolyzer configurations shown with sodium sulfate electrolyte streams according to certain embodiments.

FIGS. 4A-4C present experimental results demonstrating the impact of ammonium sulfate production on electrolyzer current efficiency. FIG. 4A presents a schematic diagram of an experimental setup. FIG. 4B presents the impact of ammonia neutralization of the anolyte on the anolyte pH, and FIG. 4C shows the corresponding current efficiency improvement.

### DETAILED DESCRIPTION

Methods of making carbon-negative fertilizer are provided. Aspects of the methods combine phosphoric acid production from rock phosphorus with precipitated calcium carbonate mineralization to produce carbon-negative fertilizer. Also provided are methods of production for monoammonium phosphate (MAP; (NH₄)H₂PO₄), diammonium phosphate (DAP; (NH₄)₂HPO₄), and/or ammonium sulfate ((NH₄)₂SO₄) fertilizers produced by methods of embodiments of the invention, as well as products produced therefrom. In addition, systems for practicing methods of embodiments of the invention are provided.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

### Methods of Phosphoric Acid and/or Ammonium Salt Production

As discussed above, aspects of the invention include methods of phosphoric acid and/or ammonium salt production. By phosphoric acid “and/or” ammonium salt production, it is meant that end products of the subject methods can include, inter alia, one or more ammonium salts, phosphoric acid, or both. In cases where ammonium salt is produced, embodiments of the subject methods include using phosphoric acid produced by the invention to produce the ammonium salt(s). In other cases, methods of the invention may be employed to produce phosphoric acid which may subsequently be employed in any suitable application at some other time or place. The suitable application in such cases may or may not involve subsequent ammonium salt production. In certain versions, at least one of these applications is ammonium salt or fertilizer production. In some cases, the protocols of the invention provide economic, environmental, and/or strategic co-benefits for the production of ammonium salts. For example, methods of the invention may be employed to reduce the amount of sulfate wastes that are produced as a result of ammonium salt production relative to conventional or currently available methods, or reduce existing stockpiles of sulfate wastes by 20% or more, such as 25% or more, such as 30% or more, such as 35% or more, such as 40% or more, such as 45% or more, such as 50% or more, such as 55% or more, such as 60% or more, such as 65% or more, such as 70% or more, such as 75% or more such as 80% or more, such as 85% or more, such as 90% or more such as 95% or more, and including by 100%. The methods described herein may also be employed to enhance carbon dioxide emissions reduction or to remove carbon dioxide from the atmosphere. For example, in some embodiments, use of the subject methods may reduce carbon dioxide emissions related to ammonium salt production as compared to conventional methods by 20% or more, such as 25% or more, such as 30% or more, such as 35% or more, such as 40% or more, such as 45% or more, such as 50% or more, such as 55% or more, such as 60% or more, such as 65% or more, such as 70% or more, such as 75% or more such as 80% or more, such as 85% or more, such as 90% or more such as 95% or more, and including by 100%.

By “ammonium salt” it is meant a compound comprising ammonium cations (NH₄⁺) and one or more suitable anions. Any desirable ammonium salt may be produced via the methods described herein. In some embodiments, the ammonium salt is an ammonium phosphate. In the present disclosure, the term “ammonium phosphate” may refer to any salt comprising one or more ammonium cations and phosphate anions (PO₄³⁻). For example, the ammonium phosphate may be comprised of monoammonium phosphate (MAP; (NH₄)H₂PO₄), diammonium phosphate (DAP; (NH₄)₂HPO₄), triammonium phosphate ((NH₄)₃PO₄), ammonium polyphosphate ([NH₄PO₃]ₙ(OH)₂), and combinations thereof. In other embodiments, the ammonium salt is ammonium sulfate ((NH₄)₂SO₄).

Methods of producing the ammonium salt include reacting rock phosphorus with sulfuric acid (H₂SO₄) and recycled phosphoric acid (H₃PO₄) to produce phosphoric acid and phosphogypsum (CaSO₄·2H₂O). “Rock phosphorus”—sometimes referred to as phosphorite, phosphate rock or rock phosphate—refers to a mineral source of phosphorous, generally corresponding to the formula Ca₅(PO₄)₃X, where X is a suitable anion (e.g., F⁻, OH⁻, Br⁻, or Cl⁻). In some cases, the rock phosphorus comprises fluorapatite (Ca₅(PO₄)₃F), hydroxyapatite (Ca₅(PO₄)₃OH or Ca₁₀(PO₄)₆(OH)₂), and/or chlorapatite (Ca₅(PO₄)₃Cl). In some cases, rock phosphorus may be found in, accompanied by, or interbedded with limestones, mudstones, shales, cherts, limestone, dolomites and sandstone. Phosphogypsum is discussed herein in its conventional sense to describe the calcium sulfate of varied hydration states generally formed as a byproduct of phosphorus fertilizer production protocols. In some embodiments, the reaction of rock phosphorus with sulfuric acid proceeds as follows:

Ca₅(PO₄)₃X+5H₂SO₄+10H₂O→3H₃PO₄+5(CaSO₄·2H₂O)+HX

The “X” in the above reaction may, in some cases, be F⁻, OH⁻, Br⁻, or Cl⁻. Phosphogypsum may also include one or more of the following: SiO₂, Cd, Al, Ba, Pb, Cr, Se, U, Fe, P, Th, Ra, and Rare Earth Elements (REEs). While phosphogypsum is generally referred to herein using the dihydrate chemical formula CaSO₄·2H₂O, it is to be understood that other forms of phosphogypsum such as hemihydrate (CaSO₄·0.5H₂O) and anhydrite (CaSO₄) forms may equally be produced and employed by the present methods and systems instead of or in addition to the dihydrate form.

Techniques for reacting rock phosphorus with sulfuric acid to produce phosphoric acid and phosphogypsum may vary. In some embodiments, methods include an acid leaching protocol. In such cases, the acid leaching protocol is a sulfuric acid leaching protocol, although leaching via other acids (e.g., HCl, H₃PO₄) is envisioned. In an acid leaching protocol, the rock phosphorus (e.g., in the form of an ore, etc.) may be combined with acid under conditions of high temperature to convert the minerals within the rock phosphorus into soluble salts. Phosphoric acid produced according to such protocols may be referred to as wet phosphoric acid (WPA). In embodiments, acid leaching occurs within an autoclave. Pressures that may be used can vary and include, e.g., 0.2 MPa or more, 0.3 Mpa or more, 0.4 Mpa or more, 0.5 Mpa or more, 0.6 Mpa or more, 7 Mpa or more, 8 Mpa or more, and including 9 Mpa or more. Temperatures that may be used range from, e.g., 400 K to 600 K, such as 410 K to 590 K, such as 420 K to 580 K, such as 430 K to 570 K, such as 440 K to 560 K, such as 450 K to 550 K, such as 460 K to 540 K, and including 470 K to 530 K. Acid leaching is described in further detail in, for example, U.S. Pat. Nos. 3,087,809; 3,741,752; 3,773,891; 3,809,549; 3,880,981; 4,410,498; 4,098,870; 4,872,909; 6,383,255; 6,406,676; 6,471,743; 7,387,767; 8,025,859; 9,732,400; and 10,808,296; the disclosures of which are incorporated by reference herein in their entirety. In embodiments, methods for phosphoric acid production involve feeding rock phosphorus to a reactor with concentrated sulfuric acid, typically in the range 93-98 wt. %, along with recycled phosphoric acid and process water recovered from the calcium sulfate solid-liquid separation. Produced wet phosphoric acid concentrations typically range between 26-30 wt. % P₂O₅ (19.5-22.8% H₃PO₄; Beltrami et al., 2014) but may be higher. In other embodiments, methods for phosphoric acid production involve feeding rock phosphorus to a reactor with dilute sulfuric acid produced directly by salt splitting electrolysis.

Methods of the invention also include converting the phosphogypsum to a calcium-containing solid product and thereby generating an aqueous sulfate. The generated aqueous sulfate may vary. In some cases, the aqueous sulfate may be sodium sulfate (Na₂SO₄), potassium sulfate (K₂SO₄), calcium sulfate (CaSO₄), lithium sulfate (Li₂SO₄), magnesium sulfate (MgSO₄), ammonium sulfate ((NH₄)₂SO₄), and the like, or combinations thereof. In certain cases, the aqueous sulfate is sodium sulfate. In some cases, the generated aqueous sulfate is electrolyzed, as discussed in further detail below.

In some cases, the calcium-containing solid product is calcium carbonate (CaCO₃). Where the inorganic alkaline solid is calcium carbonate, the inorganic alkaline solid is precipitated calcium carbonate (PCC). “PCC” is discussed herein in its conventional sense to refer to calcium carbonate (CaCO₃) that is produced via artificial or synthetic means. Put another way, PCC described in the instant disclosure is distinct from natural ground calcium carbonate (GCC). For example, PCC is not limestone that had been produced (e.g., mined) by natural processes. Additionally, PCC for use in embodiments of the invention may not constitute calcium carbonate that is a product of an organism, including but not limited to gastropod shells, eggshells, and shellfish skeletons. In some cases, the PCC employed in the invention is, at the time of its use, precipitated relatively recently with respect to the geologic time scale, such as 100 years ago or less, 90 years ago or less, 80 years ago or less, 70 years ago or less, 60 years ago or less, 50 years ago or fewer, 40 years ago or less, 30 years ago or less, 20 years ago or less, 10 years ago or less, 5 years ago or less, 1 year ago or less, 6 months ago or less, 3 months ago or less, 1 month ago or less, 15 days ago or less, 10 days ago or less, 5 days ago or less, 1 day ago or less, 10 hours ago or less, 5 hours ago or less, 1 hour ago or less, 30 minutes ago or less, 10 minutes ago or less, and including 5 minutes ago or less. The PCC may consist of any convenient form of calcium carbonate. In some instances, the PCC is in a form selected from calcite, aragonite, vaterite, and amorphous calcium carbonate, or combinations thereof. In some cases, PCC of the invention comprises calcite. In additional embodiments, PCC of the invention comprises aragonite. In still additional embodiments, PCC of the invention comprises vaterite. In still additional embodiments, PCC of the invention comprises amorphous calcium carbonate or a combination of crystalline and amorphous calcium carbonate. In some embodiments, the inorganic alkaline solid product is a calcium hydroxide alkaline solid product. In other words, the inorganic alkaline solid product comprises or is formed from slaked lime (Ca(OH)₂). Precipitates according to some embodiments are selected from calcite, aragonite, vaterite, disordered dolomite, magnesite, lansfordite, nesquehonite, dypingite, hydromagnesite, as well as combinations thereof.

Protocols for precipitating the calcium-containing solid may vary. In some embodiments, PCC formation occurs according to the following reaction:

XCO₃(aq)+CaSO₄(s,aq)→XSO₄(aq)+CaCO₃(s)

where X is a suitable counterion. While the source of carbonate may in some instances vary, methods according to some embodiments include receiving the carbonate (XCO₃) from the reaction of base with carbon dioxide (e.g., as discussed below) during a carbon capture process. Similarly, while the source of calcium sulfate (CaSO₄) may vary, the calcium sulfate may in some cases be from a gypsum source or a phosphogypsum source. In the instant case, the source of calcium sulfate is phosphogypsum produced as a result of phosphoric acid production (e.g., discussed in detail herein).

In some cases, methods include leaching the phosphogypsum, and using the resulting leachate for precipitation. Precipitation may or may not also involve a separate metathesis step beforehand. For example, in some cases, methods include metathesis in one or more metathesis reactors, where said metathesis is sufficient to cause transformation of the solid sulfate waste to a solid carbonate. Residual material (e.g., calcium, magnesium) in solution may subsequently be precipitated out of the sulfate stream from the metathesis in carbonate reactors. In some cases, there is no bifurcation of metathesis and carbonate reactors, and precipitation occurs in the same precipitator or set of precipitators. In some cases, methods include calcium sulfate leaching in place of the metathesis to supply aqueous calcium sulfate for precipitation.

In some cases, a solvent may be added to the calcium sulfate (i.e., phosphogypsum) to form a solution, slurry or suspension prior to reacting with the carbonate source. Suitable solvents that may be used for forming a gypsum solution, slurry, or suspension include aprotic polar solvents, polar protic solvents, and non-polar solvents. Suitable aprotic polar solvents may include, but are not limited to, propylene carbonate, ethylene carbonate, butyrolactone, acetonitrile, benzonitrile, nitromethane, acetonitrile, nitrobenzene, sulfolane, dimethylformamide, N-methylpyrrolidone, or the like. Suitable polar protic solvents may include, but are not limited to, water, aqueous sulfate solution, nitromethane, and short chain alcohols. Suitable short chain alcohols may include, but are not limited to, one or more of methanol, ethanol, propanol, isopropanol, butanol, or the like. Suitable non-polar solvents may include, but are not limited to, cyclohexane, octane, heptane, hexane, benzene, toluene, methylene chloride, carbon tetrachloride, or diethyl ether. Co-solvents may also be used. In a certain embodiment, the solvent added to gypsum is water or aqueous sulfate solution. To form a slurry or suspension, an amount of water or aqueous solution is added to partially dissolve the phosphogypsum, such that some of the gypsum is fully dissolved and some of the phosphogypsum remains in solid form. In another embodiment, water or aqueous solution is added to phosphogypsum to form a slurry, wherein the percent of solids in the slurry is 5-50%, or 20-40%, or 30-35%.

Following precipitation, the calcium-containing solid product may be subjected to one or more further treatment steps such as washing and solid-liquid separation. In some embodiments, methods include setting the calcium-containing solid product. The initial calcium-containing solid product composition can include not only compounds in the solid state, but also compounds in a liquid state, e.g., liquid water. “Setting” the initial calcium-containing solid product composition is used interchangeably with “drying” the solid composition and includes placing the solid composition in an environment such that there is evaporation of liquid from the solid composition. By removing a liquid from the solid composition, the chemical composition and thereby physical properties of the solid composition can be altered, e.g., a reduced volume of liquid can cause solutes dissolved in the liquid to transition to a solid state. For example, the calcium-containing solid product composition can be placed on a solid surface so that it is not in contact with another liquid, e.g., so that liquid from the solid composition can evaporate and the solid composition will not gain liquid from another liquid. In some cases, the composition is placed within a thickener configured to reduce the liquid content of the composition. Thickeners of interest have an inlet for receiving a slurry of the inorganic alkaline solid product composition and an outlet where processed inorganic alkaline solid product is output with a lower water content. Thickeners may operate by maintaining a fluidized bed of settled slurry particles that pass to a filter press for solid-liquid separation, with thickener overflow water returned to the process. Residual liquid may subsequently evaporate from solids exiting the filter press. In some cases, methods include ways of increasing the rate of evaporation, e.g., flowing a gas past the solid composition, applying a reduced gas pressure to the solid composition, increasing the temperature of the solid composition, or a combination thereof. Flowing the gas past the solid composition can be performed, for example, with a fan. A pump, e.g., a vacuum pump, can be employed to reduce the gas pressure, thereby increasing the rate of evaporation. The temperature of the solid composition can be increased, e.g., using an electric heater or a natural gas heater, to a temperature such as ranging from 25 °C to 95 °C, such as from 35 °C to 80 °C In embodiments, the setting can be done simply by air drying for 1-30 days or by drying with elevated temperature (for minutes—hours at 30-200 °C).

In some embodiments, methods include subjecting the calcium-containing solid product composition to a separation process. The term “separation process” is used herein in its conventional sense to refer to the conversion of a mixture of chemical substances to a plurality of different products. As discussed above, products of the precipitation process include a calcium-containing solid and an aqueous sulfate solution. In some cases, the separation process includes separating water from the calcium-containing solid. In additional cases, the separation process includes separating sulfate from the calcium-containing solid product. In still additional cases, the separation process includes separating an aqueous sulfate from the calcium-containing solid product. In select cases, the separation process involves the use of a filter press. Filter presses operate by injecting a slurry into one or more chambers. Pressure in the chambers is increased, and liquid is strained through a filter (e.g., using pressurized air or water). The type of filter press may vary. Examples include plate and frame filter presses, automatic filter presses, recessed plate filter presses, and membrane filter presses. Where aqueous sulfate is separated from the calcium-containing solid product, the aqueous sulfate may in some versions be electrolyzed.

In some cases, the ammonium salt is a carbon-negative ammonium salt. In other words, production of the ammonium salt results in a reduction of CO₂, including a net reduction of atmospheric CO₂. In some such cases, methods of the invention include a CO₂ sequestering protocol. In some such cases, methods include reacting a basic solution with a CO₂ containing gas to form an aqueous carbonate. The basic solution may vary. In some embodiments, the basic solution comprises sodium hydroxide (NaOH). In additional embodiments, the basic solution is an alkaline solution comprising ammonia (NH₃). In select versions, the basic solution is obtained from electrolyzing the aqueous sulfate, as described in greater detail below. The CO₂ containing gas may be pure CO₂ or be combined with one or more other gasses and/or particulate components, depending upon the source, e.g., it may be a multi-component gas (i.e., a multi-component gaseous stream). While the amount of CO₂ in such gasses may vary, in some instances the CO₂ containing gasses have a pCO₂ of 10³ or higher, such as 10⁴ Pa or higher, such as 10⁵ Pa or higher, including 10⁶ Pa or higher. The amount of CO₂ in the CO₂ containing gas, in some instances, may be 20,000 or greater, e.g., 50,000 ppm or greater, such as 100,000 ppm or greater, including 150,000 ppm or greater, e.g., 500,000 ppm or greater, 750,000 ppm or greater, 900,000 ppm or greater, up to including 1,000,000 ppm or greater (In pure CO₂ exhaust the concentration is 1,000,000 ppm) In some instances may range from 10,000 to 500,000 ppm, such as 50,000 to 250,000 ppm, including 100,000 to 150,000 ppm. The temperature of the CO₂ containing gas may also vary, ranging in some instances from 0 to 1800 °C, such as 100 to 1200 °C and including 600 to 700 °C.

In some instances, the CO₂ containing gasses are not pure CO₂, in that they contain one or more additional gasses and/or trace elements. Additional gasses that may be present in the CO₂ containing gas include, but are not limited to water, nitrogen, mononitrogen oxides, e.g., NO, NO₂, and NO₃, oxygen, HF, SiF₄ and other volatile fluoride compounds, sulfur, monosulfur oxides, (e.g., SO, SO₂ and SO₃), volatile organic compounds, e.g., benzo(a)pyrene C₂OH₁₂, benzo(g,h,l)perylene C₂₂H₁₂, dibenzo(a,h)anthracene C₂₂H₁₄, etc. Particulate components that may be present in the CO₂ containing gas include, but are not limited to particles of solids or liquids suspended in the gas, e.g., heavy metals such as strontium, barium, mercury, thallium, etc.

In certain embodiments, CO₂ containing gasses are obtained from an industrial plant, e.g., where the CO₂ containing gas is a waste feed from an industrial plant. Industrial plants from which the CO₂ containing gas may be obtained, e.g., as a waste feed from the industrial plant, may vary. Industrial plants of interest include, but are not limited to, power plants and industrial product manufacturing plants, such as but not limited to chemical, fertilizer, biofuel, and mechanical processing plants, refineries, cement plants, steel plants, etc., as well as other industrial plants that produce CO₂ as a byproduct of fuel combustion or other processing step (such as calcination by a cement plant or CO₂ off gassing by a phosphoric acid plant). Waste feeds of interest include gaseous streams that are produced by an industrial plant, for example as a secondary or incidental product, of a process carried out by the industrial plant.

Of interest in certain embodiments are waste streams produced by industrial plants that combust fossil fuels, e.g., coal, oil, natural gas, as well as man-made fuel products of naturally occurring organic fuel deposits, such as but not limited to tar sands, heavy oil, oil shale, etc. In certain embodiments, power plants are pulverized coal power plants, supercritical coal power plants, mass burn coal power plants, fluidized bed coal power plants, gas or oil-fired boiler and steam turbine power plants, gas or oil-fired boiler simple cycle gas turbine power plants, and gas or oil-fired boiler combined cycle gas turbine power plants. Of interest in certain embodiments are waste streams produced by power plants that combust syngas, i.e., gas that is produced by the gasification of organic matter, e.g., coal, biomass, etc., where in certain embodiments such plants are integrated gasification combined cycle (IGCC) plants. Of interest in certain embodiments are waste streams produced by Heat Recovery Steam Generator (HRSG) plants. Waste streams of interest also include waste streams produced by cement plants. Cement plants whose waste streams may be employed in methods of the invention include both wet process and dry process plants, which plants may employ shaft kilns or rotary kilns, and may include pre-calciners. Each of these types of industrial plants may burn a single fuel, or may burn two or more fuels sequentially or simultaneously. A waste stream of interest is industrial plant exhaust gas, e.g., a flue gas. By “flue gas” is meant a gas that is obtained from the products of combustion from burning a fossil or biomass fuel that are then directed to the smokestack, also known as the flue of an industrial plant.

In some instances, the CO₂ sequestering protocol comprises direct air capture (DAC). DAC encompasses a class of technologies and methods capable of separating carbon dioxide CO₂ directly from ambient air. A DAC system of the invention may be any system that captures CO₂ directly from air and generates a product that includes CO₂ at a higher concentration than that of the air that is input into the DAC system or that generates dissolved aqueous carbonate solution. DAC systems are systems that extract CO₂ from the air using media that binds to CO₂ but not to other atmospheric chemicals (such as nitrogen and oxygen). As air passes over the CO₂ binding medium, CO₂ “sticks” to the binding medium. DAC systems of interest include, but are not limited to: hydroxide based systems and CO₂ sorbent/temperature swing based systems. In some instances, the DAC system is a hydroxide based system, in which CO₂ is separated from air by contacting the air with is an aqueous hydroxide liquid. Examples of hydroxide based DAC systems include, but are not limited to, those described in PCT published application Nos. WO/2009/155539; WO/2010/022339; WO/2013/036859; and WO/2013/120024; the disclosures of which are herein incorporated by reference. Where hydroxide-based systems are employed, capture of CO₂ in an aqueous hydroxide may proceed as follows:

CO₂(g)+H₂O(I)=H₂CO₃(aq)

H₂CO₃(aq)+XOH(aq)→XCO₃(aq)+H₂O(I)

where X is a suitable counterion. In some cases, the method can use gases containing concentrated carbon dioxide by bubbling gas directly through a solution in which CaCO₃ precipitation is occurring using a disseminator or other suitable system to produce gas bubbles. In some cases, the DAC system can include an air contactor configured as a cooling tower, except the volumetric flux of air relative to that of hydroxide solution is approximately 50 times higher than standard cooling towers.

Methods of the invention also include electrolyzing the aqueous sulfate. Protocols used for electrolyzing the aqueous sulfate may vary. “Electrolysis” and “electrolyzing” are referred to in their conventional sense to describe to a chemical reaction that is driven by an electric current. In embodiments, the electrolysis reaction proceeds as follows:

X_{2/m}SO₄(aq)+H₂O(I,g)→(2/m)X(OH)ₘ(aq)+H₂SO₄(aq)

and

H₂O(I,g)→H₂(g)+½O₂(g)

where X^{m+} is a suitable counterion with valence m. Counterions may include, but are not limited to, K⁺, Ca²⁺, Na⁺, Li⁺, NH₄⁺ and Mg²⁺. Remaining water, hydrogen ions (H⁺), and sulfate ions (SO₄²⁻) comprise a sulfuric acid solution. In addition, hydrogen (H₂) and oxygen (O₂) gasses may be evolved. Electrolytic protocols for use in the subject methods may vary. While the current applied to an electrolyzer in embodiments of the invention may vary, in some instances the applied current ranges from 10 mA/cm² to 1,000 mA/cm², such as 60 to 600mA/cm², and including 150 to 300 mA/cm². In addition, the cell voltage at which the electrolyzing occurs may vary. In some embodiments, the electrolyzing occurs at a cell voltage ranging from 1 V to 15 V, such as 2 V to 10 V, and including 3 V to 7 V. Electrolytic protocols may have any convenient source of electricity. In some instances, the source of electricity for the process is a low-carbon energy source generated by solar, wind, hydroelectric, geothermal, hydrogen, nuclear, or fusion power plants, with or without battery energy storage, that can optionally be purchased from the electrical grid.

In embodiments, electrolysis of the aqueous sulfate via the subject methods produces an acidic solution and a basic solution. The acidic solution produced in the electrolytic protocol can include, but is not limited to, sulfuric acid (H₂SO₄), hydrochloric acid (HCl) and hydrofluoric acid (HF), and the like, or combinations thereof. In some embodiments, the acidic solution comprises H₂SO₄. In additional embodiments, the acidic solution comprises HF or hydrofluorosilicic acid (HFSA). In other embodiments, the acidic solution comprises HCl. The basic solution may likewise vary. In some embodiments, the basic solution is an alkaline solution. Basic solutions of interest may include, but are not limited to, sodium hydroxide (NaOH), potassium hydroxide (KOH), and magnesium hydroxide (Mg(OH)₂). In select cases, the basic solution comprises NaOH. In additional cases, the basic solution comprises KOH. In still additional cases, the basic solution includes magnesium hydroxide (Mg(OH)₂). In yet additional cases, the basic solution comprises ammonia (NH₃).

Electrolytic protocols of an embodiment of the invention include the use of an electrolyzer stack of one or more electrochemical cells. The number of electrochemical cells may vary, and can range from, e.g., 1 to 30, such as 10 to 20. Each electrochemical cell may include an anode within an anode chamber containing an anolyte, a cathode within a cathode chamber containing a catholyte, and one or more membranes separating the anode and cathode chambers. In embodiments, the electrolyzers contain titanium mesh or foam anodes coated in precious metal oxide catalyst suitable for the oxygen evolution reaction in acidic solution conditions. The electrolyzers may also contain nickel or stainless steel mesh or foam cathodes, suitable for the water reduction in alkaline solution conditions. In some embodiments, the anode is an acid-resistant anode (e.g., consisting of titanium, platinized titanium, carbon, or other conductive support). In embodiments, the anode includes a catalyst for water oxidation (e.g., platinum, iridium oxide, ruthenium oxide, mixed metal oxide, or other catalyst suitable for water oxidation) deposited on the anode. In some cases, the cathode includes porous titanium, stainless steel, nickel or other material suitable for water reduction. The anolyte within the anode chamber may vary. In certain cases, the anolyte comprises water. In some cases, the anolyte comprises the aqueous sulfate such as sulfuric acid or ammonium sulfate. In select cases, the anolyte (e.g., comprising the aqueous sulfate) is recirculated. Similarly, the catholyte within the cathode chamber may vary. In some cases, the catholyte comprises water. In select versions, the catholyte comprises the aqueous sulfate and hydroxide. In certain instances, methods include recirculating the catholyte.

Membranes for use in electrolysis include anion exchange membranes (AEMs), cation exchange membranes (CEMs), and bipolar membranes (BPMs). As is understood in the electrochemical arts, cation exchange membranes, which primarily consist of negatively charged groups (anions), prevent anions from passing through the membrane while allowing positively charged groups (cations) to pass through. In some cases, the cation exchange membrane is configured so that sodium cation (Na⁺) crosses the cation exchange membrane to the cathode chamber. As is understood in the electrochemical arts, AEMs, which primarily consist of positively charged groups (cations), prevent cations from passing through the membrane while allowing negatively charged groups (anions) to pass through. In some embodiments, the AEM is configured so that sulfate anion (SO₄²⁻) crosses the anion exchange membrane. Bipolar membranes may be configured to split water into protons and hydroxide ions.

In embodiments, methods include the use of one of the following: A stack of anion exchange membrane (AEM)-separated, two-chamber water electrolysis and electrodialysis cells containing an anode for production of acid and oxygen and a cathode for production of base and hydrogen (also referred to as the AEM system); a stack of cation exchange membrane (CEM)-separated two-chamber water electrolysis and electrodialysis cells (also referred to as the CEM system) cells containing an anode for production of acid and oxygen and a cathode for production of base and hydrogen; a stack of three-chamber water electrolysis and electrodialysis cells containing a CEM, an AEM, an anode for production of acid and oxygen, and a cathode for production of base and hydrogen (also referred to as the three-chamber cells); or a stack of bipolar membrane electrodialysis (BMED) cells containing an AEM, a CEM and a bipolar membrane, with a single anode and cathode per stack (also referred to as the BMED system). Any of these electrochemical units may also contain additional components that serve to protect the ion exchange membranes and/or electrode components from degradation or that improve the current efficiency of the system by facilitating acid/base separation.

In some embodiments, electrolyzers of interest include the AEM system, i.e., an electrolyzer stack of one or more electrochemical cells comprising an anode within an anode chamber containing an anolyte, a cathode within a cathode chamber containing a catholyte, and an anion exchange membrane separating the anode and cathode chambers. Exemplary electrolysis protocols according to such embodiments may be found in International Application No. PCT/US2022/039829, filed on Aug. 9, 2022; herein incorporated by reference in its entirety. In certain cases, the anion exchange membrane is configured so that sulfate anion crosses the anion exchange membrane to the anode chamber where sulfuric acid is generated. Methods may include maintaining a low concentration of base (OH⁻) in the catholyte relative to the concentration of acid (H⁺) in the anolyte, where in some instances the magnitude of the H⁺:OH⁻ ratio ranges from 5 to 100,000, such as 10 to 100 and including 2 to 200,000, where the relatively lower concentration of base is provided by flowing the catholyte through the cathode chamber, e.g., as a total stack flow rate ranging in some instances from 300 to 10,000 liters per minute (L/min) such as 500 to 1,000 L/min for a 1 metric ton CO₂ mineralization per day system, e.g., by recirculating fluid from the reactor through the cathode chamber.

In certain embodiments, the electrolyzers for use in the methods are configured as three-chamber systems designed to produce concentrated acid solutions at concentrations between 0.05 to >2.0 M and concentrated hydroxide solutions at concentrations between 0.5-2.0 M with production of gaseous hydrogen and oxygen, and with the concentrated hydroxide solution suitable for direct air capture of carbon dioxide using an air contactor. The system includes a cell or stack of cells consisting of an anode chamber separated from the sulfate feed solution chamber by an AEM as well as a cathode chamber separated from the sulfate feed solution chamber by a CEM. In still other embodiments, the electrochemical unit configured as a BMED system is designed to produce concentrated acid solutions at concentrations between 0.05 to >2.0 M and concentrated hydroxide solutions at concentrations between 0.5-2.0 M, and with the concentrated hydroxide solution suitable for direct air capture of carbon dioxide using an air contactor.

In embodiments, the process avoids the usual pitfalls of electrochemical acid-base production by maintaining a low concentration of OH⁻ in the feed solution or catholyte contacting the AEM, such that the ratio of sulfate (SO₄²⁻) to hydroxide (OH⁻) in the feed solution or catholyte is greater than 10. This configuration ensures that the flux of sulfate ions across the anion exchange membrane (AEM) is greater than the flux of hydroxide ions, minimizing Faradaic losses and increasing energy efficiency. The precipitation of carbonate, hydroxide, and hydroxycarbonate minerals consumes alkalinity, so the concentration of produced sulfuric acid is greater than the concentration of hydroxide in the catholyte or center chamber solution by a factor of 5 or greater. Suitable AEMs minimize voltage by allowing a sufficiently high sulfate flux, while limiting proton leakage, and are durable over the pH range 0-14.

In embodiments, methods include maintaining a relatively low concentration of base (OH⁻) in the catholyte (AEM system) or the sulfate feed solution (three-chamber and BMED systems) relative to the concentration of acid (H⁺) in the anolyte by recirculating fluid from mineralization through the cathode chamber (AEM system) or the cathode and sulfate feed solution chambers (three-chamber and BMED systems) rather than using the same solution feeds into the cathode and anode chambers, such that although protons and hydroxides are produced at the same rate in the electrochemical cell, the system generates an acid concentration in the anolyte that is much higher than (by at least about 5 times to about 200,000 times) the base concentration in the solution contacting the AEM, because the fluids are circulated separately. This configuration (i) minimizes Faradaic losses by migration of OH⁻ across the anion exchange membrane and resulting loss reaction: OH⁻+H⁺→H₂O in the electrochemical cell and (ii) protects the anion exchange membrane from degradation in the strong base. In embodiments, methods also include sequestering carbon dioxide as mineralized carbonate, e.g., calcium carbonate, and producing sulfuric acid by reacting sulfate solids, e.g., calcium sulfate solids, with electrochemically produced hydroxide solution contacted with carbon dioxide directly from air or from a more concentrated source. In addition, methods may include recirculating water at a constant rate through the anode chamber to allow for accumulation of sulfuric acid, e.g., at cell flow rate ranging in some instances from 15 to 100 L/min, such as 60 to 90 L/min and including 10 to 300 L/min for a 1 metric ton CO₂ mineralization per day system.

In other embodiments, the electrolyzer of interest configured as a CEM system is designed to produce dilute sulfuric acid at concentrations between 0.05-0.5 M and concentrated hydroxide solutions at concentrations between 0.5-2.0 M with production of hydrogen and oxygen, with the hydroxide solution suitable for direct air capture of carbon dioxide using an air contactor. The produced sulfuric acid contains substantial quantities, up to 1 M, sodium sulfate salt, so the use of this electrolyzer configuration will be limited.

Electrolytic protocols that may be adapted for use in the subject methods may be found in PCT patent application serial no. PCT/US2022/039829 filed on Aug. 9, 2022, the disclosure of which is incorporated by reference in its entirety. In addition protocols may be adapted from U.S. Provisional Patent Application Nos. 63/415,168; 63/443,217; and 63/443,268; the disclosures of which are herein incorporated by reference in their entirety.

In embodiments, dilute or concentrated sulfuric acid produced by electrolysis is reacted with rock phosphorus to produce the phosphoric acid. Complete dissolution of phosphate from certain types of rock phosphorus can be achieved using dilute sulfuric acid, with concentrations as low as 100 mM or less than 2 wt. % (Mendes et al., 2020). For example, the range of sulfuric acid concentrations entering the phosphoric acid production process may be 5-98 wt. % such as 10-28 wt. % or 60 to 80 wt. % or 80 to 98 wt. %. The produced sulfuric acid from electrolysis may be in the range 2-25 wt. %. In select cases, the concentration of the sulfuric acid obtained from electrolyzing the aqueous sulfate ranges from 5 wt. % to 80 wt. %. In some embodiments, the sulfuric acid may be concentrated to up to 98 wt. % with a suitable concentration method such as multi-effect evaporation with up to three effects with or without mechanical vapor recompression to reduce energy consumption. Sulfuric acid concentrations exceeding about 70 wt. % require modifications to the heat exchangers and thus a separate evaporator system must be built to achieve concentrations between about 60 and 80 wt. % or 80 and 98 wt. %. When concentrated, the concentration of the sulfuric acid may be, for example, 0.5 M or more, such as 0.6 M or more, such as 0.7 M or more, such as 0.8 M or more, such as 0.9 M or more, such as 1 M or more, such as 1.1 M or more, such as 1.2 M or more, such as 1.3 M or more, such as 1.4 M or more, and including 1.5 M or more. In other embodiments, produced dilute sulfuric acid may be used to dilute conventional concentrated sulfuric acid from 98 wt. % to 93 wt. %. The phosphoric acid concentration produced by sulfuric acid reaction with rock phosphorus depends on the feed sulfuric acid concentration. For example, a feed sulfuric acid concentration of 10.7 wt. % (e.g., 1 M H₂SO₄) generates a phosphoric acid concentration of 9.8 wt. % when calcium sulfate dihydrate is produced. A feed sulfuric acid concentration of 60 wt. % generates a phosphoric acid concentration of 74.4 wt. %.

In certain cases, methods of the invention may be characterized as applying an electric current to drive the conversion of calcium sulfate to PCC. For example, methods may include subjecting calcium sulfate (i.e., phosphogypsum), a base (i.e., OH⁻) and carbon dioxide to electrolysis. In select embodiments, electrolysis proceeds, as follows:

CaSO₄·2H₂O+CO₂(g)+electricity→H₂SO₄(aq)+CaCO₃(s)+H₂(g)+½O₂(g)

As shown above, sulfuric acid (H₂SO₄), PCC (CaCO₃), hydrogen gas (H₂) and oxygen gas (O₂) are products of the above-described embodiment of the electrolytic protocol. In other words, sulfuric acid (~1 M), base (e.g., aqueous NaOH), green hydrogen, and oxygen are produced by water electrolysis in aqueous sulfate solution.

In some cases, methods include cyclic steps of electrochemical production of sulfuric acid at the anode and a hydroxide aqueous solution, e.g., calcium hydroxide aqueous solution, at the cathode, wherein the hydroxide solution is reacted with carbon dioxide to produce solid carbonate, e.g., solid calcium carbonate. In embodiments, methods include cyclic steps of electrochemical production of sulfuric acid at the anode and hydroxide aqueous solution, e.g., calcium hydroxide aqueous solution, at the cathode, wherein the hydroxide solution is reacted with carbon dioxide and divalent cation, e.g., calcium ion, to produce a solid carbonate, e.g., PCC, wherein the sulfuric acid anolyte is recovered, concentrated as desired, e.g., to >70% H₂SO₄, and in some instances reacted with rock phosphorus to produce phosphoric acid, calcium sulfate, and HF, wherein the product calcium sulfate is returned to the process to produce calcium carbonate and sulfate solution, wherein the sulfate solution is returned to the electrochemical cell along with water to continue the cycle.

In some cases, methods include neutralization of the sulfuric acid in the anode chamber using ammonia (NH₃) to produce aqueous ammonium sulfate. Neutralization of the sulfuric acid reduces the leakage loss of protons across the AEM, thereby increasing the current efficiency of electrolysis from 30-75% to up to 95% or better, yielding substantial energy savings. The ammonium sulfate can be thermally decomposed to recover concentrated sulfuric acid and ammonia following methods for example described in further detail in U.S. Patent No. 2004/0234441A1 . Embodiments of the method involve thermal decomposition of ammonium sulfate salt to ammonia and concentrated sulfuric acid ranging from 95 wt. % to 100 wt. % or sulfuric acid with excess SO₃ (oleum, >100 wt. % sulfuric acid). In some embodiments, ammonia can be recycled back or looped to continue producing ammonium sulfate in the aqueous sulfate electrolyzer.

Methods of the invention also include synthesizing ammonia (NH₃) from the hydrogen produced during electrolysis. In some cases, the hydrogen gas produced by the electrochemical process is used as a feedstock for the production of low carbon intensity ammonia (also referred to as “green” ammonia). Examples of processes for green ammonia production include electrochemical and thermochemical approaches (e.g., Haber-Bosch) that use green hydrogen. The term “green hydrogen” is used to refer to approaches of producing gaseous hydrogen that reduce carbon dioxide emissions relative to the conventional steam methane reforming process. The term “green ammonia” is used to refer to approaches of producing ammonia that reduce carbon emissions relative to conventional Haber-Bosch, which emits approximately 2 metric tons (t) of CO₂ per ton of ammonia (Ghavam et al., 2021). Methods of the invention include reacting N₂ with H₂ in the presence of a metal catalyst under high temperature (e.g., 400-600 °C) and pressure (e.g., 20-100 MPa). This process proceeds as follows:

N₂+3H₂→2NH₃

Metal catalysts of interest for the synthesis of NH₃ include, for example, iron-based catalysts and ruthenium-based catalysts. Protocols for the production of NH₃ using H₂ and N₂ may be adapted from, for example, U.S. Pat. Nos. 4,166,834; 9,150,423; 9,272,920; and 10,287,173; the disclosures of which are incorporated by reference herein in their entirety.

Methods additionally include producing an ammonium salt from the ammonia. Techniques for producing the ammonium salt from the ammonia may vary depending on the ammonium salt that is desired. In embodiments, green ammonia is used to produce ammonium sulfate, monoammonium phosphate, and/or diammonium phosphate. Using produced hydrogen to generate green ammonia supplemented by a conventional ammonia source for ammonium sulfate production would generate a net carbon neutral ammonium sulfate product. If all of the ammonia used in ammonium sulfate production is green ammonia, the net carbon benefit is 0.82 metric tons of CO₂ per ton of ammonium sulfate relative to conventional methods, with 40% of that being a net removal from the atmosphere. Conventional ammonia production contributes around 0.3 t CO₂ emissions per ton of monoammonium phosphate produced, and about 0.5 t CO₂ emissions per ton of ammonium sulfate produced. Today more than 30 million tons of MAP are produced annually, so using this process in place of conventional ammonium phosphate amounts to a net reduction of at least 27 million tons per year of carbon dioxide.

In select instances, the ammonium salt is an ammonium phosphate comprising MAP or DAP. As is known in the art, mono- and di-ammonium phosphate are powdered or granular compositions produced by reaction of ammonia with phosphoric acid in varied proportions, followed by crystallization. Several commercial processes exist for the production of monoammonium phosphate that include from one to three neutralization steps wherein wet phosphoric acid is fed with ammonia for ammoniation. These processes include the Chemico process, the Dorr-Oliver, Process, the Fluor process, and the Knowes Associates Process (Hicks, 2018). The phosphoric acid fed to these processes is typically concentrated (50-52.5% H₃PO₄), and the slurry discharged from the final neutralization step is solidified and granulated. For example, MAP may be prepared by the following exothermic reaction:

H₃PO₄+NH₃→(NH₄)H₂PO₄,

In some cases where MAP is produced, the overall reaction of MAP production may be written as:

Ca_{5/3}(PO₄)(OH, F, Cl)_{1/3} (s, rock phosphorus)+5/3CO₂(g)+1/2N₂(g)+3H₂O+electricity→5/3 CaCO₃(s)+5/6O₂(g)+1/6H₂(g)+(NH₄)(H₂PO₄) (s, MAP)

In addition, DAP may be prepared by the following reaction:

H₃PO₄+2NH₃→(NH₄)₂HPO₄,

Furthermore, where the ammonium salt is an ammonium phosphate comprised of triammonium phosphate, the ammonium salt may be prepared by treating the phosphoric acid with ammonia such that the following reaction occurs:

H₃PO₄+3NH₃→(NH₄)₃PO₄

As is understood in the art, the proportion of ammonia added relative to phosphoric acid will influence the form of ammonium phosphate produced.

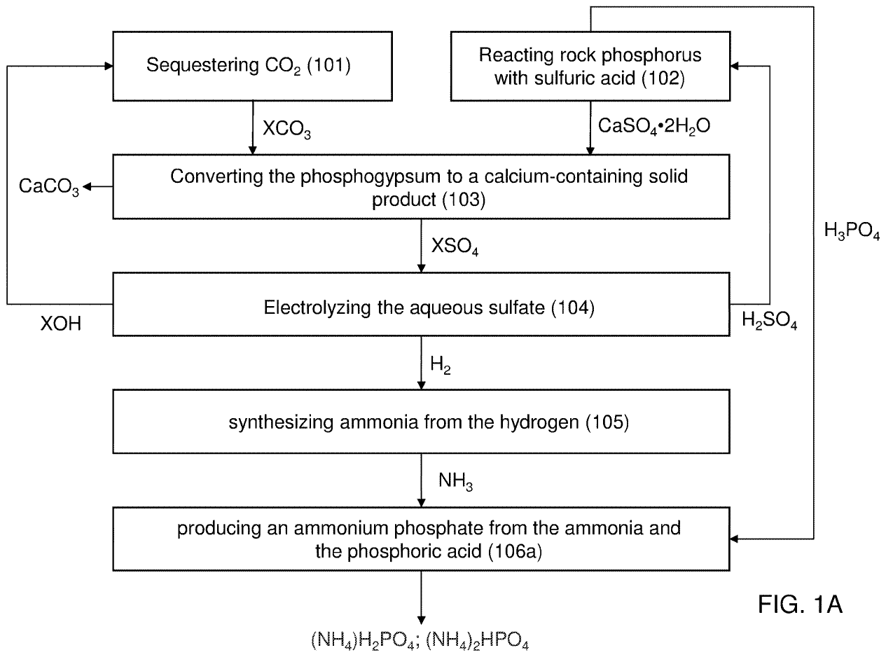

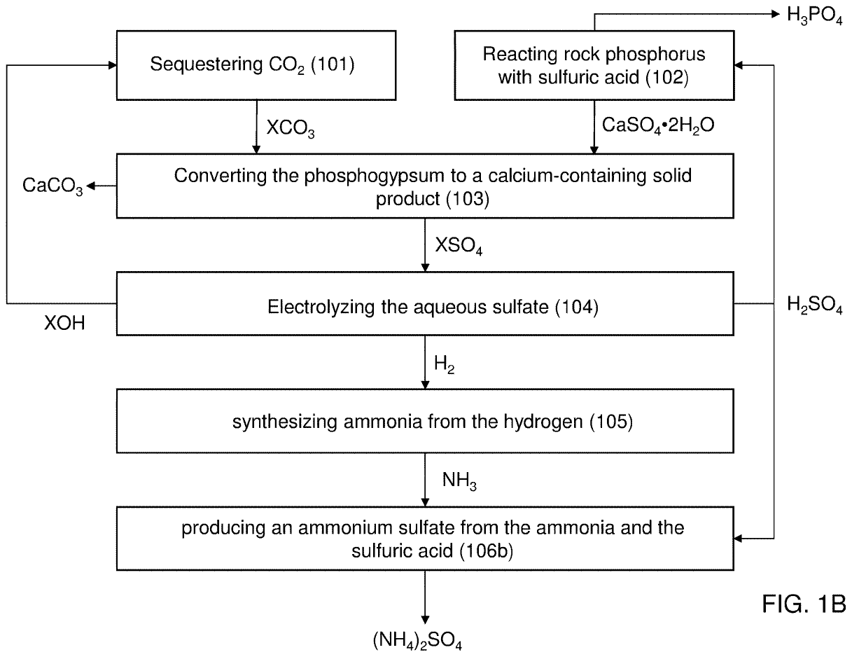

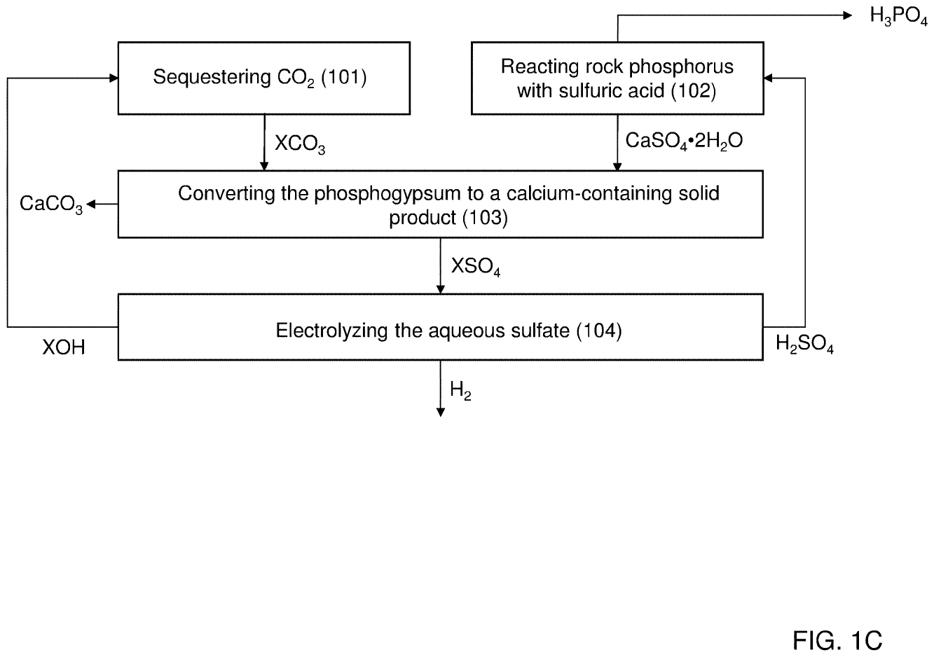

FIG. 1A presents a flowchart for producing an ammonium phosphate according to certain embodiments. As shown in FIG. 1A, a CO₂ sequestering protocol in step 101 employs a basic solution (XOH; where X is a suitable counterion such as Na⁺ or K⁺) to capture gaseous CO₂ and produce an aqueous carbonate (XCO₃; where X is a suitable counterion such as Na⁺ or K⁺). Rock phosphorus is digested with sulfuric acid (H₂SO₄) along with recycled phosphoric acid (H₃PO₄) in step 102, resulting in the production of phosphogypsum (CaSO₄·2H₂O) and phosphoric acid. The step encompasses conventional wet phosphoric acid production processes, which is a multi-step process involving a high percentage recycle of phosphoric acid to the rock phosphorus digestion process not illustrated in detail in the diagram. The phosphogypsum is converted to a calcium-containing solid product (CaCO₃) in step 103, resulting in the production of an aqueous sulfate (XSO₄; where X is a suitable counterion such as Na⁺ or K⁺). Said aqueous sulfate is subsequently electrolyzed in step 104, resulting in an acidic solution (H₂SO₄), a basic solution (XOH), gaseous hydrogen (H₂), and gaseous oxygen (not shown) being produced. In some cases, the aqueous sulfate from step 103 is supplemented with additional aqueous sulfate from another source for electrolysis. The basic solution is supplied to step 101 for the CO₂ sequestering protocol. The acidic solution is supplied to step 102 for reaction with rock phosphorus. Hydrogen from the electrolysis in step 104 is used to synthesize ammonia (NH₃) in step 105. This ammonia and the phosphoric acid from step 102 are used to produce an ammonium phosphate ((NH₄)H₂PO₄; (NH₄)₂HPO₄) in step 106a.

In embodiments, the ammonium salt is ammonium sulfate. As known in the art, ammonium sulfates may take the form of aqueous solutions or solid powdered or granulated products. In such embodiments, methods include combining the ammonia produced as described above with sulfuric acid directly in the recirculating anolyte solution to reduce Faradaic losses by proton leakage in the electrolysis or BMED system. In some cases, the sulfuric acid is sulfuric acid obtained from electrolyzing the aqueous sulfate (e.g., discussed above). The ammonium sulfate may be produced by sulfuric acid neutralization as follows:

2NH₃+H₂SO₄→(NH₄)₂SO₄

Ammonium sulfate may be produced by several conventional methods including neutralization of dilute sulfuric acid with ammonia followed by concentration and, in some cases, crystallization. In certain cases, producing the ammonium sulfate includes introducing a mixture of ammonia gas and water into a sulfuric acid solution. In other cases, producing the ammonium sulfate includes spraying sulfuric acid into a reaction chamber filled with ammonia gas. In alternative arrangements where a CO2 sequestering protocol is employed that involves combining aqueous ammonia with carbon dioxide to produce an aqueous carbonate (i.e., ammonium carbonate), methods of the invention may include producing the ammonium sulfate and PCC in the same reaction by reacting the ammonium carbonate with the phosphogypsum, as follows:

(NH₄)₂CO₃+CaSO₄→(NH₄)₂SO₄+CaCO₃

The resulting PCC (i.e., CaCO₃) may subsequently be processed as described above.

FIG. 1B presents a flowchart for a method of producing an ammonium sulfate. The steps shown in FIG. 1B are the same as those described above with respect to FIG. 1A, with the exception that sulfuric acid from electrolysis in step 104 is employed to produce the ammonium salt ((NH₄)₂SO₄) in step 106b instead of phosphoric acid (H₃PO₄) in step 106a. The steps shown in FIG. 1C are the same as those described above with respect to FIG. 1A, with the exception that hydrogen from electrolysis step 104 is not employed for ammonia production, and phosphoric acid is produced instead of ammonium salts. The phosphoric acid may be employed for any suitable purpose, including other phosphate fertilizer production steps (not shown).

Methods according to some embodiments also include producing a fertilizer from the ammonium salt (e.g., ammonium phosphate, ammonium sulfate). The term “fertilizer” is employed in its conventional sense to refer to a product that supplies an essential nutrient such as nitrogen, phosphorus and/or sulfur to an agricultural system. In some cases, the fertilizer comprises phosphoric acid or a product generated therefrom. In some cases, the ammonium salt employed in the fertilizer is a carbon-negative ammonium salt. In some such cases, the ammonium salt employed in or as the fertilizer was produced using a CO₂ sequestering protocol, such as those discussed above. The amount of CO₂ sequestered per unit mass of ammonium salt may vary. In some cases the ratio of the mass of sequestered CO₂ to the mass of ammonium salt produced may be 0.2:1 or more, 0.3:1 or more, 0.4:1 or more, 0.5:1 or more, 0.6 to 1 or more, and including 0.7:1 or more. In certain instances, the CO₂ sequestering protocol comprises sequestering a mass of CO₂ per ton of ammonium salt produced that ranges from 0.2 tons to 0.8 tons, such as 0.5 tons to 0.7 tons, and including 0.6 tons to 0.7 tons. In select cases, the CO₂ sequestering protocol comprises sequestering 0.6 tons of CO₂ per ton of ammonium salt produced. In some embodiments, the CO₂ sequestering protocol comprises sequestering 0.63 tons of CO₂ per ton of ammonium salt produced. In other cases, the CO₂ sequestering protocol comprises sequestering 0.33 tons of CO₂ per ton of ammonium salt produced.

Methods of fertilizer production may vary as desired. In some instances, fertilizer production involves converting the ammonium salt to a form that is salable as a fertilizer. In some embodiments, methods include producing a fertilizer blend, where the fertilizer may include two or more different types of fertilizer that are sold together as a single product. Methods of fertilizer production may include but are not limited to steam granulation, chemical granulation, compaction, and bulk blending. In select cases, methods include producing a multinutrient fertilizer comprising two or more nutrient compounds. General classes of nutrient compounds include nitrogen-based compounds, phosphorus-based compounds and potassium-based compounds. Where the ammonium salt is an ammonium phosphate (e.g., MAP, DAP), such salts may be considered multinutrient fertilizers because they include nitrogen (i.e., in the form of ammonium ion) and phosphorus (i.e., in the form of phosphate ion). In select cases, fertilizer production includes adding potassium to the ammonium salt to produce an “NPK” fertilizer. Methods of fertilizer production may also include the addition of one or more micronutrients, such as but not limited to boron, zinc, molybdenum, iron, and manganese.

Products of the subject methods may have various uses. Fertilizers may be used in one or more agricultural applications. For example, the produced fertilizers may be employed to provide nutrients for use in the cultivation of one or more crops, including but not limited to maize/corn, wheat, fruit and tree nuts, soybeans, rice, and the like. In embodiments, the oxygen gas produced at the anode is off-gassed to the atmosphere, is collected to be compressed and sold, or is used as an oxidant in the sulfuric acid extraction process to avoid sulfate-reducing conditions. In addition to being used to produce ammonia, hydrogen gas may be combusted to produce heat and/or energy that may be supplied to another part of the process (e.g., ammonia generation).

Sulfuric acid produced as described above may find multiple uses. As described above, sulfuric acid is often employed in phosphate fertilizer production. As such, embodiments of the invention include employing the produced sulfuric acid in phosphate fertilizer production. In some embodiments, methods include concentrating the produced sulfuric acid prior to employing it for phosphate fertilizer production. When concentrated, the concentration of the sulfuric acid may be, for example, 0.5 M or more, such as 0.6 M or more, such as 0.7 M or more, such as 0.8 M or more, such as 0.9 M or more, such as 1 M or more, such as 1.1 M or more, such as 1.2 M or more, such as 1.3 M or more, such as 1.4 M or more, and including 1.5 M or more. As noted above, a byproduct of phosphorous fertilizer production is phosphogypsum. Such phosphogypsum may then be used to create more PCC, and so on. The sulfate is substantively recycled to reduce the accumulation of sulfate wastes during mining and fertilizer production.

The calcium containing solid may also have various uses. In some cases where the calcium containing solid includes precipitated calcium carbonate (PCC), said calcium containing solid may be employed in, for example, iron purification, oil drilling fluids, sugar refining, chalk, paint, resin, ceramic glazes, antacids, calcium supplements, and food additives. In certain cases, PCC may be used as a feedstock for lime (CaO) production. In some cases, said lime is employed in cement production. The production of lime from PCC is described in U.S. Provisional Patent Application No. 63/443,217 and International Application No. PCT/US2023/034367; the disclosures of which are incorporated by reference herein in their entirety. The PCC (CaCO₃) may be used as an additive to conventional blended hydraulic cements by admixture with ordinary Portland cement at a concentration up to 15 wt. % according to ASTM C595/C595M Performance Specifications.

### Systems for Phosphoric Acid and/or Ammonium Salt Production

As discussed above, aspects of the invention include systems for phosphoric acid and/or ammonium salt production. Systems of interest include a reactor configured to react rock phosphorus with sulfuric acid (H₂SO₄) to produce phosphoric acid (H₃PO₄) and phosphogypsum (CaSO₄·2H₂O). Any suitable reactor configured to combine a mineral source including rock phosphorus and an acidic solution under conditions sufficient to extract phosphorus from the mineral source may be employed. In select versions, the reactor is or comprises an autoclave. In some instances, pressures that may be used in the subject reactors can vary and include, e.g., 0.2 MPa or more, 0.3 MPa or more, 0.4 MPa or more, 0.5 MPa or more, 0.6 MPa or more, 7 MPa or more, 8 MPa or more, and including 9 MPa or more. Temperatures that may be used in the subject reactors range from, e.g., 400 K to 600 K, such as 410 K to 590 K, such as 420 K to 580 K, such as 430 K to 570 K, such as 440 K to 560 K, such as 450 K to 550 K, such as 460 K to 540 K, and including 470 K to 530 K. Devices and protocols that may be adapted for use in the subject reactor are described in, for example, U.S. Pat. Nos. 3,087,809; 3,741,752; 3,773,891; 3,809,549; 3,880,981; 4,410,498; 4,098,870; 4,872,909; 6,383,255; 6,406,676; 6,471,743; 7,387,767; 8,025,859; 9,732,400; and 10,808,296; the disclosures of which are incorporated by reference herein in their entirety. Systems of the invention may also include a pulverizer or crusher configured to reduce mineral source to finer particles.

Systems of the invention also include a precipitator (sometimes referred to as a mineralized carbonate production reactor or precipitation reactor) configured to convert the phosphogypsum to a calcium-containing solid product and thereby generate an aqueous sulfate. Any device(s) (e.g., reactor) suitable for the precipitation of an inorganic alkaline solid may be employed as the subject precipitator. In some cases, the precipitator is in a phosphogypsum-receiving relationship with the reactor, i.e., such that phosphogypsum is received in the precipitator from the rock phosphorus reactor. In some embodiments, the precipitator is operably connected to the reactor and a source of carbonate. The precipitator may introduce the reagents in any suitable manner (e.g., disintegration and/or spraying, etc.). In some cases, the precipitator is a continuous flow mixer. Precipitators may additionally include an agitator configured to mix the slurry undergoing precipitation. Agitators of interest may include one or more sets of rotors and blades. Where multiple rotors are employed, embodiments of the precipitation reactor include rotors rotating in opposite directions or in the same directions at different speeds. The blades, or the like, can create shear forces, turbulence and under and overpressure pulses, which grind, or disintegrate and spray the material. Precipitators that may be adapted for use are described in, e.g., U.S. Pat. No. 8,012,445, the disclosure of which is incorporated by reference herein.

Systems described herein also include an electrolysis unit consisting of or including an electrolyzer configured to electrolyze the aqueous sulfate to produce hydrogen (H₂). In embodiments, electrolyzers include a stack of cation exchange membrane (CEM)-separated two-compartment water electrolysis and electrodialysis cells containing an anode for production of acid and oxygen and a cathode for production of base and hydrogen. In embodiments, some such systems are designed to produce both relatively concentrated acid and relatively concentrated base simultaneously at a range of current densities between 10 and 1000 mA/cm² and cell voltages between 3.5 and 6 V. In embodiments, CEM-separated systems of the invention are configured to produce relatively dilute sulfuric acid, and the produced acid contains a substantial quantity of recirculated salt, with salt concentrations >0.1 M and produced acid concentrations up to 0.5 M. The CEM-separated system may be configured to produce a relatively concentrated base that may or may not contain a substantial quantity of salt. The range of produced base concentrations includes 0.1 to >1.5 M, with salt concentrations ranging from ppm-level up to saturation with respect to a recirculated soluble sulfate salt such as Na₂SO₄. Being an electrolysis system, the CEM system produces gaseous hydrogen (H₂) and oxygen (O₂) products in equi-molar quantity to the theoretical acid and base produced but with a higher current efficiency (up to 95-100%) due to lower Faradaic losses of the produced gasses compared to the produced acid and base.

The CEM system may be configured for use with a component that removes carbon dioxide from the air or from point sources and produces aqueous carbonate solutions such as Na₂CO₃, for example using an air contactor in the case of air or a gas disseminator in the case of more concentrated carbon dioxide point sources. Unlike an AEM-separated system, the high concentration of produced base in the CEM-separated system enables direct air capture of carbon dioxide, allowing the system to accomplish carbon dioxide direct air capture and geologically permanent sequestration of carbon dioxide in carbonate solid phases.

In systems where dilute sulfuric acid and concentrated base are produced, CEM electrolyzers may be configured to produce sulfuric acid at concentrations between 0.05-0.5 M and concentrated hydroxide solutions at concentrations between 0.5-2.0 M with production of hydrogen and oxygen. The concentrated hydroxide solution is suitable for direct air capture of carbon dioxide using an air contactor. The produced sulfuric acid can contain a substantial concentration of sodium sulfate salt, from 0.25 to 1 M, such as 0.25-0.5 M, or 0.4-0.6 M or >0.5 M. Carbonate or carbonate-free hydroxide solutions may be reacted with a stream containing metal sulfates (e.g. calcium and or magnesium sulfate as solids or aqueous solutions) to precipitate solid carbonate phases including but not limited to calcite, aragonite, vaterite, disordered dolomite, magnesite, lansfordite, nesquehonite, dypingite, and hydromagnesite. Alternatively, the CEM system is configured to use the entire base stream to produce solid hydroxide phases such as brucite, Mg(OH)₂, and/or portlandite, Ca(OH)₂ instead of solid carbonate phases. In some cases, the CEM system integrates a water treatment step or steps designed to remove residual alkaline earth elements (especially Ca and Mg) as well as other trace impurities by liming with a portion of the produced base stream, by ion exchange, or by a combination of these and/or other brine treatment steps. The treated brine stream is returned to the electrolyzer in a continuous fashion to enable continuous, integrated operation. In some cases, electrolyzers include an anion exchange membrane. Exemplary electrolysis protocols according to such embodiments may be found in International Application No. PCT/US2022/039829, filed on Aug. 9, 2022; herein incorporated by reference in its entirety. In certain cases, the anion exchange membrane is configured so that sulfate anion crosses the anion exchange membrane to the anode chamber where sulfuric acid is generated. Systems may be configured to maintain a low concentration of base (OH⁻) in the catholyte relative to the concentration of acid (H⁺) in the anolyte, where in some instances the magnitude of the H⁺:OH⁻ ratio ranges from 5 to 100,000, such as 10 to 100 and including 2 to 200,000, where the relatively lower concentration of base is provided by flowing the catholyte through the cathode chamber, e.g., as a total stack flow rate ranging in some instances from 300 to 10,000 liters per minute (L/min) such as 500 to 1,000 L/min for a 1 metric ton CO₂ mineralization per day system, e.g., by recirculating fluid from the reactor through the cathode chamber.

In other embodiments, electrolyzers include a stack of three-compartment water electrolysis and electrodialysis cells containing a CEM, an AEM, an anode for production of acid and oxygen, and a cathode for production of base and hydrogen (also referred to as the three-compartment system). In certain embodiments, the three-compartment system is configured to produce concentrated acid solutions at concentrations between 0.05 to >2.0 M, such as 1 M, and concentrated hydroxide solutions at concentrations between 0.5 to 2.0 M, such as 1 M, with production of gaseous hydrogen and oxygen. Hydroxide solution concentrations >0.5 M are suitable for direct air capture of carbon dioxide using an air contactor. Embodiments include a cell or stack of cells consisting of an anode compartment separated from the sulfate feed solution compartment by an AEM as well as a cathode compartment separated from the sulfate feed solution compartment by a CEM. The systems configured to contain three-compartment electrolysis cells may be designed to produce both relatively concentrated acid and relatively concentrated base simultaneously at a range of current efficiencies between 80-100%. In embodiments, the produced acid and base are both substantively salt-free (ppm range concentrations of recirculated salt).

Bipolar membranes (BPMs) may likewise be employed in the subject systems. In some such cases, electrolyzers are configured to perform bipolar membrane electrodialysis (BMED). In some cases, the electrochemical unit configured as a BMED system is designed to produce concentrated acid solutions at concentrations between 0.05 to >2.0 M and concentrated hydroxide solutions at concentrations between 0.5-2.0 M.

Any of the above electrochemical units may also contain additional components that serve to protect the ion exchange membranes and/or electrode components from degradation or that improve the current efficiency of the system by facilitating acid/base separation. Each salt splitting approach has a unique set of embodiments. In some cases the system is configured to recirculate a soluble sulfate salt (e.g., Na₂SO₄, K₂SO₄, Li₂SO₄, (NH₄)₂SO₄, or other sulfate salt), at a concentration between 0.5 M and saturation, which serves the role of supplying a sufficient quantity of sulfate anion and a cation (e.g., Na⁺) to the electrochemical unit to enable efficient production of acid and base.

In some embodiments, systems are configured such that calcium sulfate is introduced to one or more precipitators or reactors where it is converted to calcium carbonate by metathesis reaction with carbon dioxide from air and alkalinity produced in a two-chamber water electrolyzer. In an embodiment, calcium sulfate is introduced into a train of from one up to three or more metathesis reactors where solid calcium sulfate is supplied via a suitable method such as a screw conveyor or by pipe as a slurry discharged from phosphoric acid production. In the metathesis reactors the solid calcium sulfate is converted to calcium carbonate and the final solid product is recovered by a suitable method of solid-liquid separation. The residual aqueous calcium sulfate is then taken to a series of precipitators or reactors that produce either solid calcium carbonate or aqueous calcium chloride, aqueous calcium sulfate, or a combination of products. Effluent from the precipitators or reactors is recirculated through the cathode chamber of the water electrolyzer, where sulfate liberated crosses an anion exchange membrane to gradually accumulate sulfuric acid in a recirculating anolyte solution. During operation, sulfuric acid and calcium carbonate are produced by reacting a calcium sulfate source with electrochemically produced hydroxide contacted with carbon dioxide derived from atmospheric air, although more concentrated sources of carbon dioxide can also be used (e.g., as discussed above).

Systems of the invention also include an ammonia synthesizer configured to synthesize ammonia (NH₃) from the hydrogen. Any convenient device configured to synthesize ammonia from hydrogen and nitrogen gas (N₂) may be employed. In some instances, the ammonia synthesizer is configured to carry out a Haber-Bosch process. In some such instances, the synthesizer may include a catalyst (e.g., a metal catalyst). In embodiments, the synthesizer include a plurality (e.g., 4) beds comprising the catalyst. Metal catalysts of interest for the synthesis of NH₃ include, for example, iron-based catalysts and ruthenium-based catalysts. The synthesizer is configured to pass the nitrogen gas and hydrogen gas across the beds to form the liquid ammonia. Ammonia synthesizers and components thereof (e.g., catalysts) that may be adapted for use in the present systems are described in U.S. Pat. Nos. 9,150,423; 9,272,920; 10,131,545; 10,322,940; 10,597,301; and 10,974,970; the disclosures of which are herein incorporated by reference in their entirety.

Systems may additionally include one or more brine treatment modules configured to treat the aqueous sulfate prior to its recirculation to the electrolyzer. Purification of the brine exiting the precipitation reactor may be included to prevent scaling and fouling of electrolyzer components. In addition or alternatively, the brine treatment module may be employed to selectively extract valuable elements or to remove other impurities from the aqueous solution, such that a purified sulfate brine such as sodium sulfate is produced. Modules that may be employed include, for example, filters (e.g., polishing filters) and ion exchange columns.

Systems of the invention also include an ammonium salt generator configured to produce an ammonium salt from the ammonia. Any suitable device configured to combine ammonia and an acid reagent (e.g., phosphoric acid, sulfuric acid) such that an ammonium salt is obtained may serve as the ammonium salt generator. In embodiments, the ammonium salt generator includes a reactor configured to bubble ammonia gas through an acid solution (e.g., phosphoric acid, sulfuric acid). In certain cases, the ammonium salt generation is configured to combine the acid solution with a liquid ammonia solution. In some such cases, the ammonium salt generator is configured to control the ammonia-to-phosphoric acid mole ratio during the neutralization process, e.g., so that different forms of ammonium phosphate may be formed. In some cases where the ammonium salt is ammonium sulfate, the ammonium salt generator includes sprayers for spraying sulfuric acid into a reaction chamber filled with ammonia gas.

In some cases, systems comprise a CO₂ sequestration unit. The CO₂ sequestration unit may be operably connected to any source of CO₂, including air or a point source (e.g., flue gas). In some cases, the CO₂ sequestration unit is an air contactor. Any suitable air contactor may be employed. In some instances the air contactor is a DAC system, such as a hydroxide based DAC system. DAC systems include, but are not limited to, those described in PCT published application Nos. WO/2009/155539; WO/2010/022339; WO/2013/036859; and WO/2013/120024. In select cases, the air contactor operates by bubbling gas directly through the precipitation reactor solution using a disseminator or other suitable system to produce gas bubbles. The concentrated hydroxide solution described above is suitable for direct air capture of carbon dioxide using the air contactor.

In some cases, systems are configured to produce ammonium phosphate (e.g., MAP, DAP). In such cases, systems are configured to provide dilute or concentrated phosphoric acid to the ammonium salt generator, which may be configured to carry out from one to three neutralization steps. In some cases, systems are configured such that approximately 0.63 metric tons (tons, t) of carbon dioxide is mineralized per ton of monoammonium phosphate produced. In embodiments, dilute phosphoric acid with concentrations ranging from less than 9.8 wt. % to less than 50 wt. % is fed with ammonia for ammoniation in one or more steps.

Feeding the ammonium salt generator with dilute phosphoric acid minimizes the overall energy consumption of the process when dilute sulfuric acid is used to produce phosphoric acid.

Because mono-and diammonium phosphate can be crystallized, it is possible to evaporate water for concentration of the solution using mechanical vapor recompression (MVR), which is much more energy efficient than the multi-effect evaporation process required for sulfuric or phosphoric acid concentration. For a multi-effect evaporation, the latent heat of water evaporation can be approximately divided by the number of effects. So, water evaporation requires approximately 820 KJ/kg water using a three-effect evaporator. Using mechanical vapor recompression, the evaporation of water can be as little as 5% of the latent heat or 113 kJ/kg water. For example, concentration of sulfuric acid from 10.7 wt. % to 60 wt. % using multi-effect evaporation requires approximately 6.25×10⁶ KJ/metric ton H₂SO₄ using a three-effect evaporator. The advantage of using dilute sulfuric acid (rather than sulfuric acid concentrated by multi effect evaporation) for phosphoric acid production can be clearly illustrated by determining the relative energy consumed assuming 1 M (10.7 wt. %) H₂SO₄ is produced in the electrolyzer and directly used for phosphoric acid production and subsequent ammonium phosphate crystallization, compared to the case where the produced acid is first concentrated to 60 wt. % H₂SO₄ prior to phosphoric acid production and subsequent ammonium phosphate crystallization. In this comparison, 6.7 times more energy is required overall in the case where sulfuric acid is first concentrated, because of the much higher energy requirement of multi-effect evaporation compared to the energy of MVR.

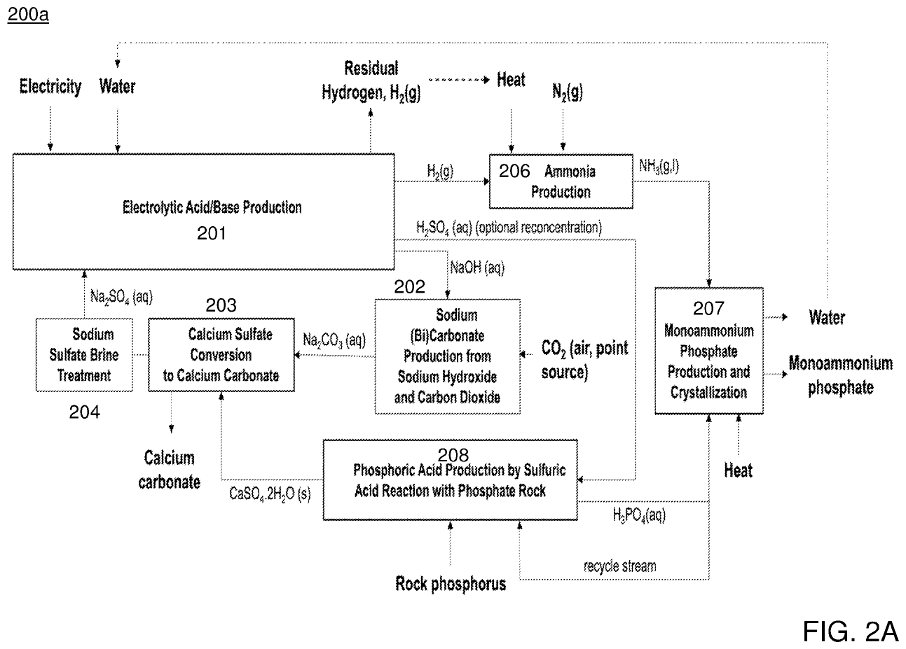

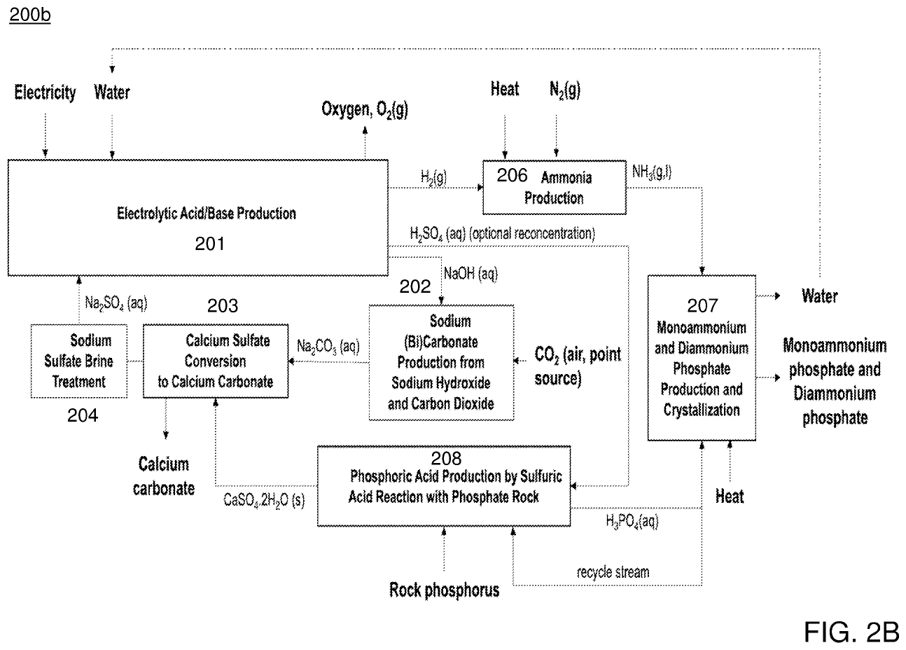

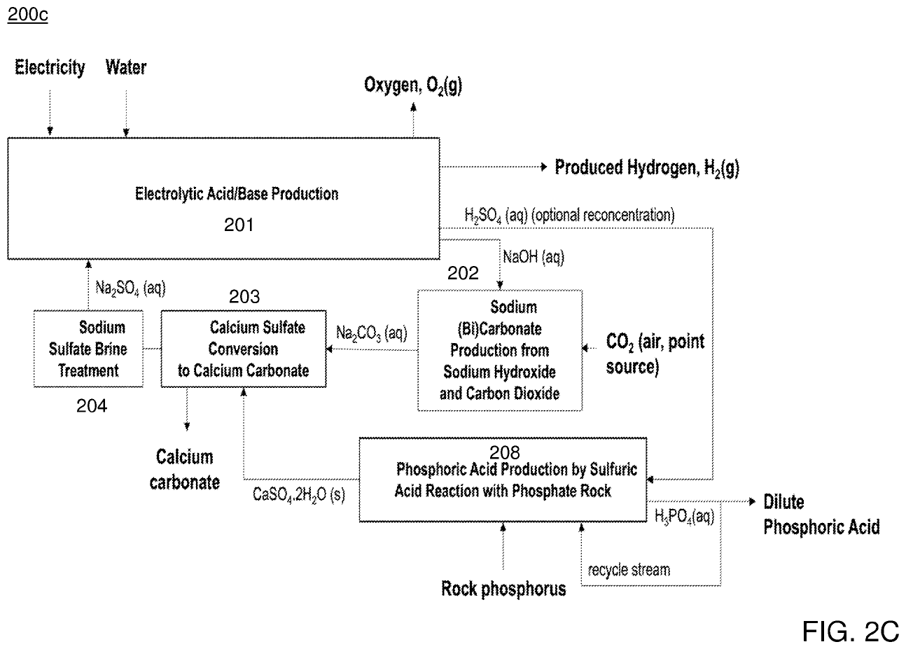

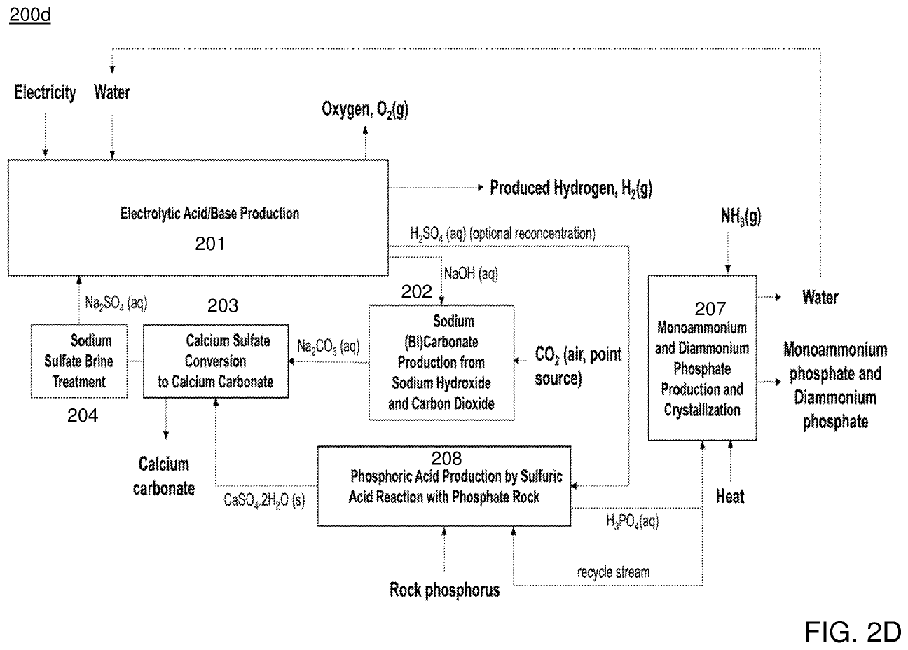

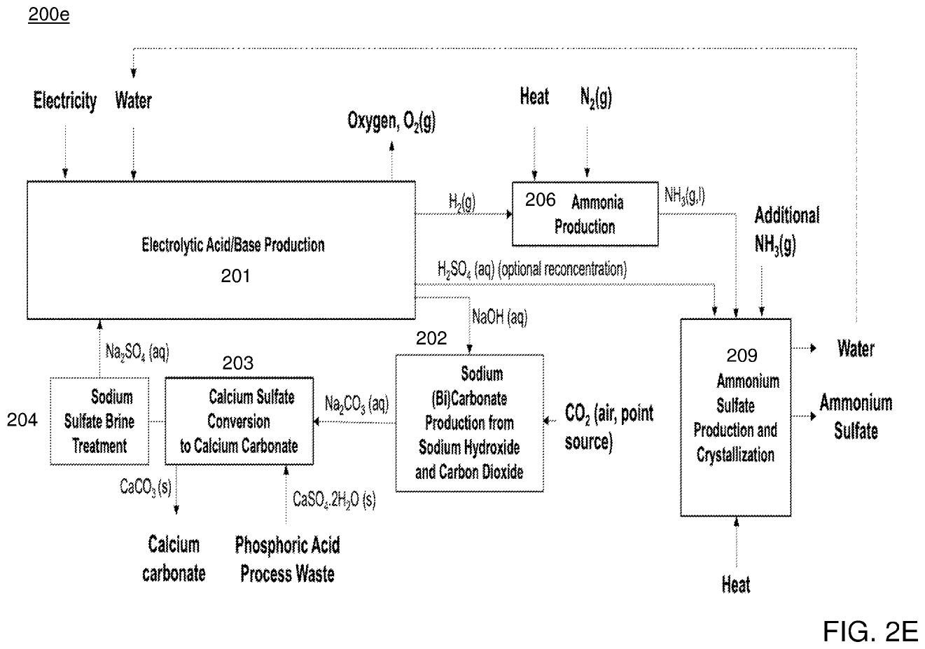

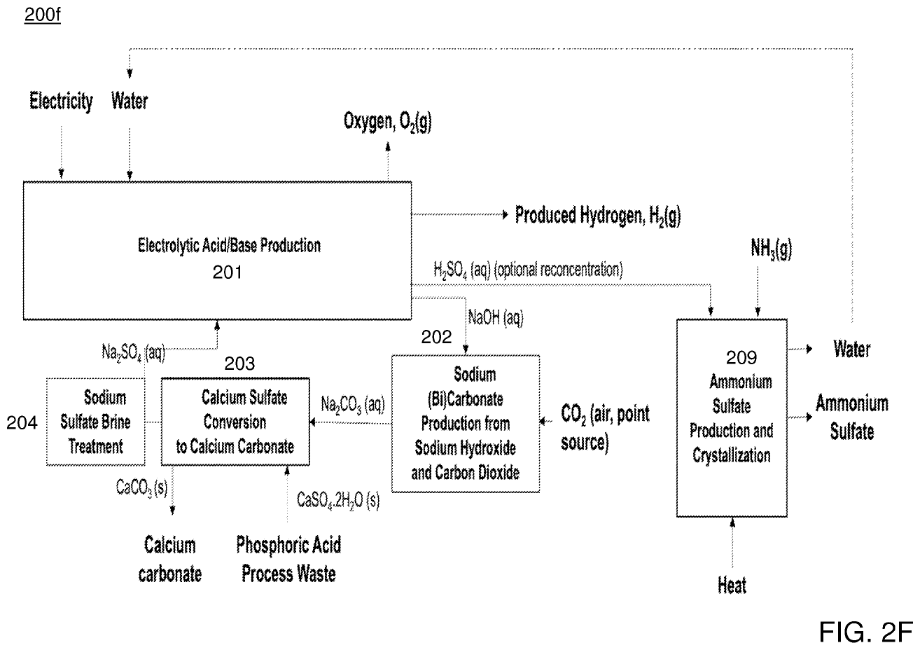

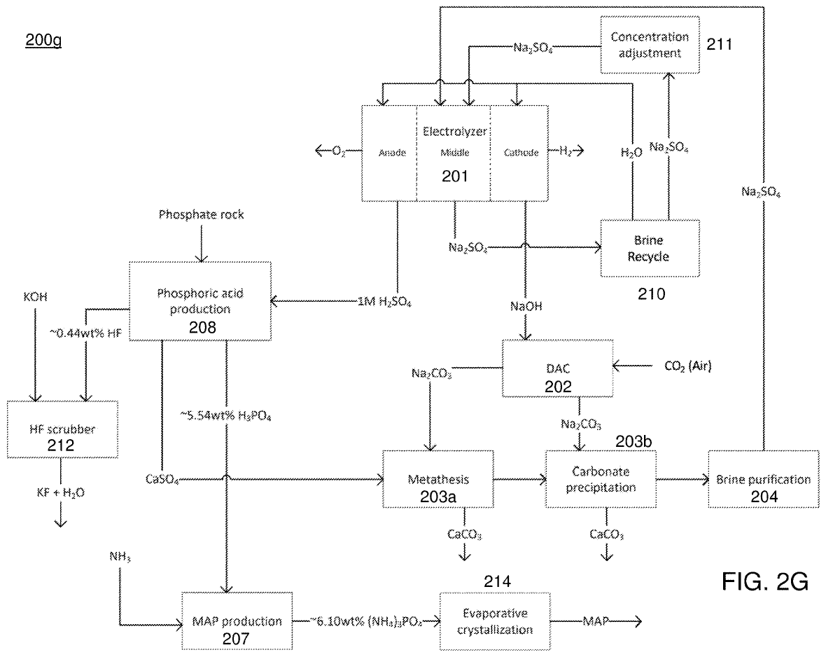

FIG. 2A depicts a flow diagram illustrating a system 200a for production of monoammonium phosphate, gaseous hydrogen, and permanent sequestration of carbon dioxide as calcium carbonate from rock phosphorus. As shown in FIG. 2A, electrolyzer 201 is configured to receive electricity, water and aqueous sulfate (Na₂SO₄), and produce hydrogen (H₂), an acidic solution (H₂SO₄), and a basic solution (NaOH). The system is configured such that basic solution from electrolyzer 201 is subsequently provided to CO₂ sequestration unit 202, which is configured to produce an aqueous carbonate (Na₂CO₃) from the basic solution and carbon dioxide (CO₂), which may be obtained from air or a point source. In addition, electrolyzer 201 is fluidically connected to reactor 208 such that the acidic solution is provided thereto. Optionally, the system is configured so that the acidic solution is concentrated prior to being supplied to reactor 208. Reactor 208 is configured to produce phosphoric acid (H₃PO₄) and phosphogypsum (CaSO₄·2H₂O) from the H₂SO₄ and recycled phosphoric acid and in some instances is configured to carry out multiple digestion steps, such as from 2 to 8 steps. System 200a includes a recycle stream configured to resupply the phosphoric acid to reactor 208 for further concentration. Reactor 208 and CO₂ sequestration unit 202 are operably connected to precipitator 203 configured to convert the phosphogypsum to a calcium-containing solid product (in this case, calcium carbonate) using the aqueous carbonate and thereby generate an aqueous sulfate. System 200a includes brine treatment module 204 configured to remove impurities from the aqueous sulfate prior to its return to electrolyzer 201 for electrolysis.

The hydrogen produced by the electrolyzer may have multiple purposes. System 200a is configured such that hydrogen is supplied to ammonia synthesizer 206 and employed along with gaseous nitrogen (N₂) to generate ammonia (NH₃). In the example of FIG. 2A, the system is configured to combust a residual amount of the hydrogen and supply the resultant heat to drive ammonia synthesis in ammonia synthesizer 206. Ammonia synthesizer 206 and reactor 208 are fluidically connected to ammonium salt generator 207 which is configured to produce configured to produce MAP from the ammonia and phosphoric acid. Ammonium salt generator 207 is fluidically connected to electrolyzer 201 such that water obtained in MAP production is recirculated to electrolyzer 201 for electrolysis.

FIG. 2B depicts a flow diagram illustrating a system 200b configured for production of monoammonium phosphate, gaseous hydrogen, and permanent sequestration of carbon dioxide as calcium carbonate from rock phosphorus. System 200b is identical to system 200a of FIG. 2A, with the exceptions that system 200b is not configured to combust the hydrogen and ammonium salt generator 207 is configured to generate both MAP and DAP. FIG. 2B also shows gaseous oxygen (O₂) being evolved from the electrolysis in electrolyzer 201.

FIG. 2C depicts a flow diagram illustrating a system 200c configured for production of dilute phosphoric acid, gaseous hydrogen, and permanent sequestration of carbon dioxide as calcium carbonate from rock phosphorus. System 200c includes the same components as system 200a of FIG. 2A, with the exceptions that ammonia synthesizer 206 and ammonium salt generator 207 are not present. In the embodiment of FIG. 2C, ammonia production from hydrogen and ammonium salt production from phosphoric acid may occur at other locations that are separate from system 200c. For example, the hydrogen and phosphoric acid may be stored and/or transported to other location for use.

FIG. 2D depicts a flow diagram illustrating a system 200d configured for production of dilute phosphoric acid, gaseous hydrogen, and permanent sequestration of carbon dioxide as calcium carbonate from rock phosphorus and ammonia. System 200d includes the same components as system 200b of FIG. 2B, with the exception that ammonia synthesizer 206 is not present. System 200d may be configured to receive ammonia from another source. Alternatively, hydrogen from electrolyzer 201 converted to ammonia at another location and/or in another system, and then returned for conversion into MAP or DAP.

In some cases, systems are configured to generate a solid or liquid ammonium sulfate. In embodiments of the subject systems, dilute sulfuric acid produced in the electrolyzer in a range of concentrations between 2-20 wt. % is fed with ammonia in one or more neutralization steps, followed by evaporative concentration by mechanical vapor recompression. In some systems configured to produce ammonium sulfate, around 0.33 t of carbon dioxide is mineralized per ton of ammonium sulfate produced. Use of dilute sulfuric acid for ammonium sulfate production rather than concentrated sulfuric acid produced by multi-effect evaporation of dilute sulfuric acid minimizes the energy consumption of the ammonium sulfate production process, because multi-effect evaporation requires much more energy per kg of water removed than MVR. In select cases, systems are configured to produce a fertilizer from the ammonium sulfate. In embodiments, the fertilizer is an aqueous solution. In other embodiments, the fertilizer is crystallized by conventional methods such as spray methods to form solid granules or powder.

FIG. 2E depicts a flow diagram illustrating a system 200e configured for production of ammonium sulfate and permanent sequestration of carbon dioxide as calcium carbonate from waste calcium sulfate and ammonia. As shown in FIG. 2E, electrolyzer 201 is configured to receive electricity, water and aqueous sulfate (Na₂SO₄), and produce hydrogen (H₂), an acidic solution (H₂SO₄), and a basic solution (NaOH). The system is configured such that basic solution from electrolyzer 201 is subsequently provided to CO₂ sequestration unit 202, which is configured to produce an aqueous carbonate (Na₂CO₃) from the basic solution and carbon dioxide (CO₂), which may be obtained from air or a point source. In addition, system 200e includes precipitator 203 configured to convert waste from phosphoric acid production (i.e., phosphogypsum) to a calcium-containing solid product (in this case, calcium carbonate) using the aqueous carbonate and thereby generate an aqueous sulfate. System 200e is configured such that hydrogen is supplied to ammonia synthesizer 206 and employed along with gaseous nitrogen (N₂) to generate ammonia (NH₃). Ammonia synthesizer 206 and electrolyzer 201 are fluidically connected to ammonium salt generator 209 configured to generate and crystalize ammonium sulfate. Water obtained in ammonium sulfate production is recirculated to electrolyzer 201 for electrolysis.

FIG. 2F depicts a flow diagram illustrating a system 200f configured for production of ammonium sulfate, gaseous hydrogen, and permanent sequestration of carbon dioxide as calcium carbonate from waste calcium sulfate and ammonia. System 200f is identical to system 200e of FIG. 2E, with the exception that ammonia synthesizer 206 is not present. System 200e may be configured to receive ammonia from another source. Alternatively, hydrogen from electrolyzer 201 converted to ammonia at another location and/or in another system, and then returned for conversion into ammonium sulfate.

FIG. 2G presents system 200g configured for MAP production according to certain embodiments. In the embodiment of FIG. 2G, electrolyzer 201 comprises an anode chamber, a middle chamber and a cathode chamber. Aqueous sodium sulfate from electrolyzer 201 is sent to brine treatment module 210. Water from the aqueous sodium sulfate is recirculated for electrolyzer 201, while sodium sulfate is provided to a concentration module 211 configured to adjust the concentration of the sodium sulfate to a level suitable for use in electrolyzer 201. System 200g also includes CO₂ sequestration unit 202, brine treatment module 204, ammonium salt generator 207, and reactor 208, which operate in essentially the same manner as described above. In the embodiment of FIG. 2G, the calcium-containing solid product (CaCO₃) is produced in separate metathesis and precipitation steps in metathesis reactor 203a and precipitator 203b, respectively. Also shown is a crystallization unit 214 configured to carry out the evaporative crystallization of the MAP produced in ammonium salt generator 207. Residual hydrofluoric acid (HF) produced by reactor 208 is neutralized in scrubber 212 configured to combine said HF with potassium hydroxide (KOH).

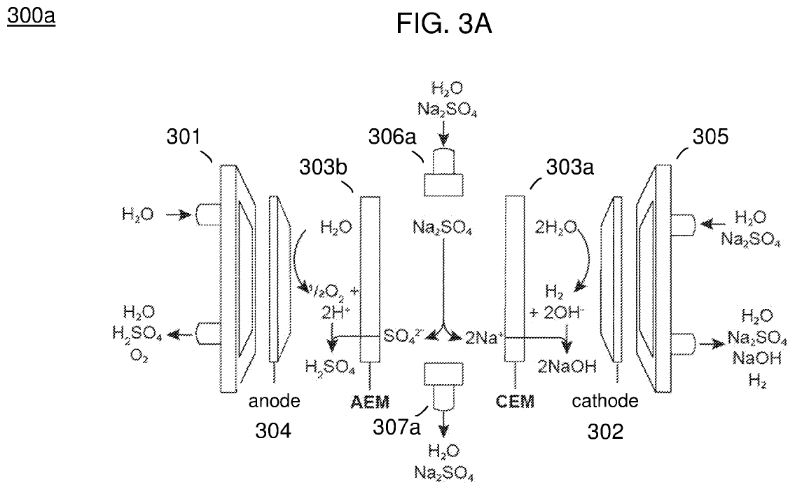

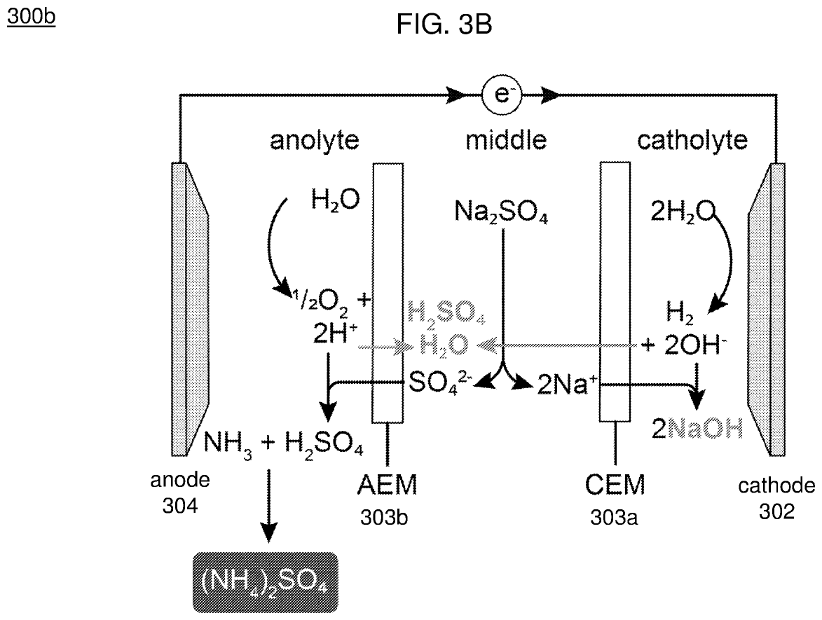

FIG. 3A-3B depict exemplary electrolyzers for use in the subject systems. FIG. 3A depicts a three-compartment electrochemical cell comprising an AEM and a CEM. Cell 300a includes exchange elements 305 and 301 having inlets and outlets for conveying liquid (i.e., anolyte and catholyte, as appropriate) to and from the cathode chamber comprising cathode 302 and anode chamber comprising anode 304, respectively. Water (H₂O) is provided to the anode chamber, while water, sulfuric acid (H₂SO₄) and oxygen (O₂) are conveyed from the anode chamber. In addition, water and sodium sulfate (Na₂SO₄) are provided to the cathode chamber, while water, sodium sulfate, sodium hydroxide (NaOH) and hydrogen (H₂) are conveyed from the cathode chamber. Cell 300a also includes inlet 306a and outlet 307a configured to pass aqueous sulfate through the cell. During electrolysis, sulfate ion (SO₄²⁻) passes through AEM 303b to form sulfuric acid in the anode chamber, while sodium ion (Na⁺) passes through CEM 303a to form sodium hydroxide in the cathode chamber. In some embodiments, catholyte and/or anolyte may be recirculated. FIG. 3B includes electrolyzer 300b having anode 304, AEM 303b, CEM 303a and cathode 302 arranged as described above with respect to FIG. 3A. Also depicted is how sulfuric acid (H₂SO₄) may be combined with ammonia to form (NH₄)₂SO₄.

The following is presented by way of explanation and not by way of limitation.

### Experimental

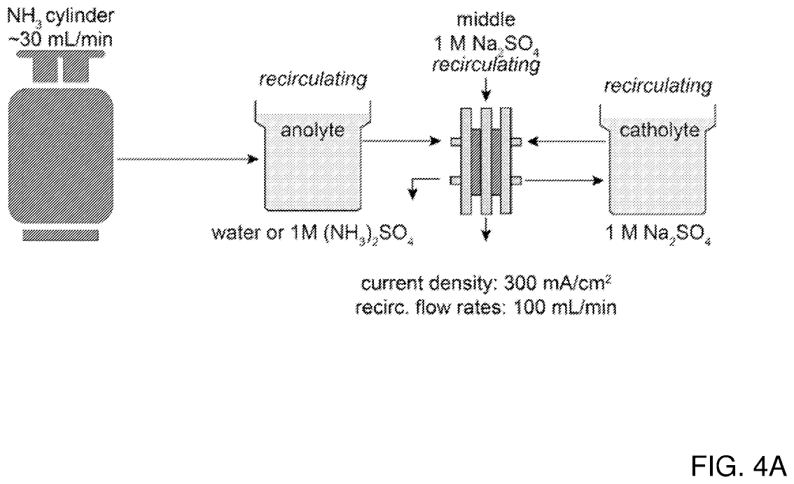

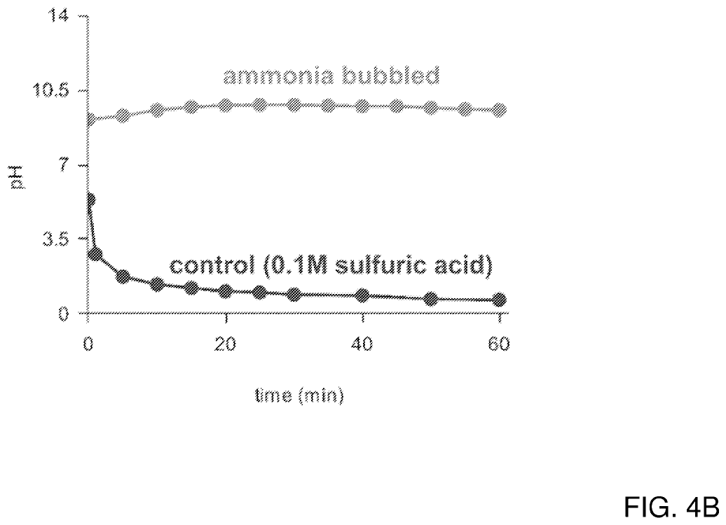

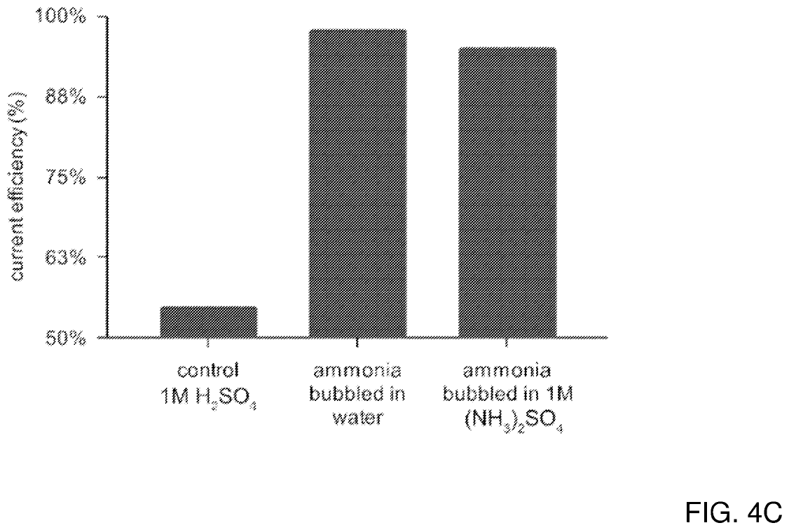

A proof-of-concept experiment was performed to demonstrate that ammonia neutralization can suppress proton leakage resulting in higher current efficiency in the electrolyzer (FIGS. 4A-4C). The experimental setup is depicted in FIG. 4A and consisted of a three-chamber electrolyzer with a Pt/C anode and Ni foam cathode, an AEM and a CEM, recirculating 1 M Na₂SO₄ solution through the center compartment. The rate of recirculation of anolyte, catholyte, and center compartment solutions were 100 mL/min. Over the course of the experiments, caustic NaOH accumulated in the catholyte, and acid or ammonium sulfate accumulated in the anolyte solution. The anolyte was either 1 M sulfuric acid (control), ammonia bubbled into water, or ammonia bubbled into 1 M ammonium sulfate. Bubbling ammonia at a rate of 30 mL/min at ambient pressure effectively neutralized the produced acid leading to a constant pH compared to the control system (FIG. 4B). After 60 min of applied current, the anolyte, middle, and catholyte solutions were sampled, and acid and base titrations were performed to evaluate the efficiency of proton and hydroxide electrolysis. The results showed that when 1 M sulfuric acid was used as the anolyte, the anolyte current efficiency was 57%, while the ammonia in water led to a current efficiency of 98% and the 1 M ammonium sulfate led to 95% (FIG. 4C). The catholyte efficiencies were ~100% in all cases. These results suggested that neutralizing sulfuric acid with ammonia successfully reduces proton leakage into the middle compartment to enable high current efficiencies in the anolyte compartment.

Notwithstanding the appended claims, the present invention may be described by the following clauses:

1. A method comprising:

reacting rock phosphorus with sulfuric acid (H₂SO₄) to produce phosphoric acid (H₃PO₄) and phosphogypsum (CaSO₄·nH₂O);

converting the phosphogypsum to a calcium-containing solid product and thereby generating an aqueous sulfate; and electrolyzing the aqueous sulfate to produce hydrogen (H₂).

2. The method according to Clause 1, further comprising synthesizing ammonia (NH₃) from the hydrogen.

3 The method according to Clause 2, further comprising producing an ammonium salt from the ammonia.

4. The method according to Clause 3, wherein the ammonium salt is an ammonium phosphate.

5. The method according to Clause 4, wherein the method comprises producing the ammonium phosphate from the ammonia and the phosphoric acid.

6. The method according to Clause 4 or 5, wherein the ammonium phosphate is monoammonium phosphate (MAP).

7. The method according to Clause 4 or 5, wherein the ammonium phosphate is diammonium phosphate (DAP).

8. The method according to any one of Clauses 3 to 7, further comprising producing a fertilizer from the ammonium salt.

9. The method according to any one of Clauses 3 to 8, wherein the ammonium salt is a carbon-negative ammonium salt.

10. The method according to Clause 9, wherein the method comprises a CO₂ sequestering protocol.

11. The method according to Clause 10, wherein the CO₂ sequestering protocol comprises sequestering gaseous CO₂ via direct air capture (DAC).

12. The method according to Clause 10, wherein the CO₂ sequestering protocol comprises sequestering gaseous CO₂ from a point source.

13. The method according to any one of Clauses 10 to 12, wherein the CO₂ sequestering protocol comprises reacting gaseous CO₂ with a base to produce an aqueous carbonate.

14. The method according to Clause 13, wherein the method comprises reacting the aqueous carbonate with the phosphogypsum to produce the calcium-containing solid product.

15. The method according to any one of Clauses 10 to 12, wherein CO₂ sequestering protocol comprises sequestering 0.6 tons of CO₂ per ton of ammonium salt produced.

16. The method according to any one of the preceding clauses, wherein the calcium-containing solid product comprises precipitated calcium carbonate (PCC).

17. The method according to any one of Clauses 1 to 8, wherein the calcium-containing solid product is a calcium hydroxide alkaline solid product.

18. The method according to any one of the preceding clauses, wherein electrolyzing the aqueous sulfate comprises producing an acidic solution.

19. The method according to Clause 18, wherein the acidic solution comprises sulfuric acid.

20. The method according to Clause 19, further comprising reacting the rock phosphorus with the sulfuric acid obtained from electrolyzing the aqueous sulfate to produce the phosphoric acid and phosphogypsum.

21. The method according to Clause 20, further comprising concentrating the sulfuric acid obtained from electrolyzing the aqueous sulfate prior to reacting it with the rock phosphorus.

22. The method according to Clause 21, wherein the concentration of the sulfuric acid obtained from electrolyzing the aqueous sulfate ranges from 5 wt. % to 80 wt. %.

23. The method according to any one of Clauses 19 to 22, wherein the ammonium salt is ammonium sulfate ((NH₄)₂SO₄).

24. The method according to Clause 23, wherein the method comprises producing the ammonium sulfate from the ammonia and the sulfuric acid obtained from electrolyzing the aqueous sulfate.

25. The method according to any one of Clauses 18 to 24, wherein electrolyzing the aqueous sulfate comprises producing gaseous oxygen (O₂).

26. The method according to any one of Clauses 18 to 24, wherein the electrolyzing comprises the use of a membrane separating an anode chamber comprising an anolyte and a cathode chamber comprising a catholyte.

27. The method according to Clause 26, wherein the method comprises recirculating fluid through the cathode chamber.

28. The method according to Clause 26 or 27, wherein the membrane is an anion exchange membrane.

29. The method according to Clause 28, wherein the anion exchange membrane is configured so that sulfate anion (SO₄²⁻) crosses the anion exchange membrane to the anode chamber where sulfuric acid is generated.

30. The method according to Clause 26 or 27, wherein the membrane is a cation exchange membrane.

31. The method according to Clause 30, wherein the cation exchange membrane is configured so that sodium cation (Na⁺) crosses the cation exchange membrane to the cathode chamber where sodium hydroxide (NaOH) is formed.

32. The method according to Clause 26 or 27, wherein the electrolyzing comprises the use of an anion exchange membrane and a cation exchange membrane.

33. The method according to any one of Clauses 26 to 32, wherein the method comprises bipolar membrane electrodialysis (BMED).

34. The method according to Clause 33, wherein the electrolytic protocol comprises the use of:
an anion exchange membrane;
a cation exchange membrane; and
a bipolar membrane.

35. The method according to Clause 2, wherein synthesizing the ammonia comprises reacting the hydrogen with nitrogen gas (N₂).

36. The method according to Clause 6, wherein the ammonium phosphate is produced by a reaction that may be written as:

Ca_{5/3}(PO₄)(OH, F, Cl)_{1/3}(s, rock phosphorus)+5/3CO₂(g)+1/2N₂(g)+3H₂O+electricity→5/3

CaCO₃(s)+5/6O₂(g)+1/6H₂(g)+(NH₄)(H₂PO₄) (s, MAP)

37. The method according to any one of the preceding clauses, wherein the rock phosphorus comprises fluorapatite.

38. The method according to any one of Clauses 1 to 36, wherein the rock phosphorus comprises hydroxyapatite.

39. The method according to Clause 16, further comprising calcining the PCC to produce lime (CaO).

40. The method according to Clause 39, further comprising making a hydraulic cement from the lime.

41. The method according to Clause 40, further comprising producing a concrete using the hydraulic cement.

42. An ammonium salt produced according to any one of Clauses 5 to 7.

43. A hydraulic cement produced according to Clause 40.

44. A concrete produced according to Clause 41.

45. A built structure produced from a hydraulic cement according to Clause 43 or a concrete according to Clause 44.

46. A system comprising:
a reactor configured to react rock phosphorus with sulfuric acid (H₂SO₄) to produce phosphoric acid (H₃PO₄) and phosphogypsum (CaSO₄·2H₂O);
a precipitator configured to convert the phosphogypsum to a calcium-containing solid product and thereby generate an aqueous sulfate; and
an electrolysis unit configured to electrolyze the aqueous sulfate to produce hydrogen (H₂)

47. The system according to Clause 46, further comprising an ammonia synthesizer configured to synthesize ammonia (NH₃) from the hydrogen.

48. The system according to Clause 47, further comprising an ammonium salt generator configured to produce an ammonium salt from the ammonia.

49. The system according to Clause 48, wherein the system is configured to produce an ammonium phosphate.

50. The system according to Clause 49, wherein the system is configured to produce the ammonium phosphate by combining the ammonia with the phosphoric acid.

51. The system according to Clause 49 or 50, wherein the system is configured to produce monoammonium phosphate (MAP).

52. The system according to Clause 49 or 50, wherein the system is configured to produce diammonium phosphate (DAP).

53. The system according to any one of Clauses 49 to 52, wherein the system is configured to produce a fertilizer from the ammonium phosphate.

54. The system according to any one of Clauses 46 to 53, further comprising a CO₂ sequestration unit.

55. The system according to Clause 54, wherein the CO₂ sequestration unit is operably connected to a source of CO₂.

56. The system according to Clause 55, wherein the source of CO 2 is air.

57. The system according to Clause 55, wherein the source of CO 2 is a point source.

58. The system according to Clause 57, wherein the point source is a flue gas.

59. The system according to any one of Clauses 54 to 58, wherein the CO₂ sequestration unit is configured to react gaseous CO₂ with a base to produce an aqueous carbonate.

60. The system according to Clause 59, wherein CO₂ sequestration unit is configured to receive the base from the electrolysis unit.

61. The system according to Clause 59, wherein the CO₂ sequestration unit is fluidically connected to the precipitator such that the aqueous carbonate is provided to the precipitator.

62. The system according to any one of Clauses 46 to 61, further comprising a brine treatment module configured to purify the aqueous sulfate from the precipitator.

63. The system according any one of Clauses 46 to 62, wherein the precipitator is in a phosphogypsum-receiving relationship with the reactor.

64. The system according to any one of Clauses 46 to 63, wherein the electrolysis unit is configured to produce sulfuric acid by electrolyzing the aqueous sulfate from the precipitator.

65. The system according to Clause 64, wherein the electrolysis unit is configured to supply the produced sulfuric acid to the reactor.

66. The method system to Clause 64 or 65, wherein the system is configured to produce ammonium sulfate ((NH₄)₂SO₄).

67. The system according to Clause 66, wherein the method comprises producing the ammonium sulfate from the ammonia and the produced sulfuric acid.

68. The system according to Clause 65, wherein the system is configured to concentrate the produced sulfuric acid.

69. The system according to Clause 68, wherein the concentration of the sulfuric acid obtained from electrolyzing the aqueous sulfate ranges from 5 wt. % to 80 wt. %.

70. The system according to any one of Clauses 46 to 69, wherein the electrolysis unit comprises a membrane separating an anode chamber comprising an anolyte and a cathode chamber comprising a catholyte.

71. The system according to Clause 70, wherein the electrolysis unit is configured to maintain a concentration of base in the catholyte that is low relative to the concentration of acid in the anolyte.

72. The system according to Clause 70 or 71, wherein the membrane is an anion exchange membrane.

73. The system according to Clause 72, wherein the anion exchange membrane is configured so that sulfate anion (SO₄²⁻) crosses the anion exchange membrane to the anode chamber where sulfuric acid is generated.

74. The system according to Clause 70 or 71, wherein the membrane is a cation exchange membrane.

75. The system according to Clause 74, wherein the cation exchange membrane is configured so that sodium cation (Na⁺) crosses the cation exchange membrane to the cathode chamber where sodium hydroxide (NaOH) is formed.

76. The system according to any one of Clauses 70 to 75, wherein the electrolysis unit comprises a cation exchange membrane and an anion exchange membrane.

77. The system according to Clause 76, wherein the electrolysis unit comprises:
an anion exchange membrane;
a cation exchange membrane; and
a bipolar membrane.

78. The system according to any one of Clauses 46 to 77, wherein the reactor is operably connected to a source of rock phosphorus.

79. The system according to Clause 78, wherein the source of rock phosphorus comprises fluorapatite.

80. The system according to Clause 78, wherein the source of rock phosphorus comprises hydroxyapatite.

81. The system according to any one of Clauses 44 to 76, wherein the system is configured to produce a calcium-containing solid product comprising precipitated calcium carbonate (PCC).

82. The system according to Clause 81, further comprising a calciner configured to produce lime (CaO) from the calcium-containing solid product.

83. The system according to any one of Clauses 46 to 53, wherein the system is configured to produce a calcium-containing solid product comprising a calcium hydroxide alkaline solid product.

84. A method of making carbon-negative fertilizer, the method comprising employing calcium sulfate waste from phosphoric acid production as a feedstock for phosphoric acid and precipitated calcium carbonate (PCC) production from rock phosphorus.

85. The method according to Clause 84, wherein the method further comprises production of gaseous hydrogen and oxygen.

86. The method according to any one of Clauses 84 or 85, wherein the precipitated calcium carbonate is a carbon-negative PCC.

87. The method according to any one of Clauses 84 to 86, wherein the phosphoric acid is reacted with ammonia to produce carbon-negative monoammonium phosphate.

88. The method according to any one of Clauses 84 to 87, wherein the phosphoric acid is reacted with ammonia to produce carbon-negative monoammonium phosphate and diammonium phosphate.

89. The method according to Clause 85, wherein the hydrogen is used to produce low-carbon intensity ammonia.

90. The method according to Clause 87 or 88, wherein the source of ammonia is low-carbon intensity ammonia.

91. A method of making a carbon-negative fertilizer, the method comprising employing calcium sulfate waste from phosphoric acid production as a feedstock for ammonium sulfate and PCC production.

92. The method according to Clause 91, wherein the method further comprises production of gaseous hydrogen and oxygen.

93. The method according to Clause 91 or 92, wherein the precipitated calcium carbonate is a carbon-negative PCC.

94. The method according to Clause 92, wherein the hydrogen is used to produce low-carbon intensity ammonia.

95. The method according to Clause 92, wherein the source of ammonia is low-carbon intensity ammonia.

96. A system configured to practice the method of any one of Clauses 84 to 95.

97. The system according to Clause 96, further comprising an electrolyzer stack of one or more electrochemical cells comprising:
an anode within an anode chamber containing an anolyte,
a cathode within a cathode chamber containing a catholyte, and an anion exchange membrane separating the anode and cathode chambers.

98. The system according to Clause 96, further comprising an electrolyzer stack of one or more electrochemical cells comprising:
an anode within an anode chamber containing an anolyte,
a cathode within a cathode chamber containing a catholyte,
a center chamber containing an aqueous sulfate solution,
an anion exchange membrane separating the anode and center chambers, and
a cation exchange membrane separating the cathode and center chambers.

99. The system according to Clause 97 or 98, wherein the mineralized carbonate production reactor is configured to receive a hydroxide solution from the cathode chamber, to generate mineralized carbonate from a sulfate feedstock and CO₂, and to return some or all of the reactor solution to the cathode chamber.

100. The system according to Clause 96, further comprising a stack of bipolar membrane electrodialysis cells.

101. The system according to Clause 100, wherein the mineralized carbonate production reactor is configured to receive a hydroxide solution from the basic solution feed, to generate mineralized carbonate from the calcium sulfate byproduct of phosphoric acid production and CO₂, and to return some or all of the reactor solution to the cathode chamber.

102. The system according to any one of Clauses 96 to 100, further comprising a sulfuric acid recovery module configured to receive sulfuric acid from the anode chamber.

103. The system according to any one of Clauses 96 to 101, wherein the system is configured as a continuous flow system.

104. The system according to any one of Clauses 73 to 103, wherein the system comprises mineralized carbonate production reactor is operably connected to a source of sulfate.

105. The system according to Clause 104, wherein the source of sulfate comprises calcium sulfate.

106. The system according to any one of Clauses 103 to 105, wherein the mineralized carbonate production reactor is operably connected to a source of CO₂.

107. The system according to Clause 106, wherein the source of CO₂ comprises air.

108. The system according to Clause 107, wherein the source of CO₂ comprises a flue gas.

109. The system according to Clause 97, wherein the system is configured to maintain a concentration of base in the catholyte that is low relative to the concentration of acid in the anolyte.

110. The system according to Clause 98, wherein the system is configured to maintain a concentration of base in the center chamber that is low relative to the concentration of acid in the anolyte.

111. The system according to Clause 97, wherein the system is configured to recirculate fluid from the mineralized carbonate production reactor through the cathode chamber.

112. The system according to Clause 98, wherein the system is configured to recirculate fluid from the mineralized carbonate production reactor through the cathode chamber and the center chamber.

### References Cited

Beltrami D., Cote G., Mokhtari H., Courtaud B., Moyer B. A. and Chagnes A. (2014) Recovery of Uranium from Wet Phosphoric Acid by Solvent Extraction Processes. Chemical Reviews 114, 12002-12023.

Davenport J., Getsinger J. and Carroll F. (1965) Wet-Process Phosphoric Acid. Foam Distribution of Sulfuric Acid. Industrial & Engineering Chemistry Process Design and Development 4, 84-88.

Fernández-Díaz, L., Pina, C. M., Astilleros, J. M. & Sánchez-Pastor, N. The carbonatation of gypsum: Pathways and pseudomorph formation. American Mineralogist 94, 1223-1234 (2009).

Ghavam S., Vahdati M., Wilson I. and Styring P. (2021) Sustainable ammonia production processes. Frontiers in Energy Research, 34.

Hicks G. C. (2018) Review of the production of monoammonium phosphate. In Manual of Fertilizer Processing. Routledge. pp. 289-305.

King M., Moats M. and Davenport W. G. (2013) Sulfuric acid manufacture: analysis, control and optimization. Newnes.

Kyriakou V., Garagounis I., Vourros A., Vasileiou E. and Stoukides M. (2020) An electrochemical haber-bosch process. Joule 4, 142-158.

La Plante, E. C. ; Simonetti, D. A. ; Wang, J. ; Al-Turki, A. ; Chen, X. ; Jassby, D. ; Sant, G. N. Saline Water-Based Mineralization Pathway for Gigatonne-Scale CO2 Management. ACS Sustainable Chemistry & Engineering 2021, 9(3), 1073-1089.

Lal, R. Carbon sequestration. Philosophical Transactions of the Royal Society B: Biological Sciences 363, 815-830 (2008).

Liu H. (2014) Ammonia synthesis catalyst 100 years: Practice, enlightenment and challenge. Chinese Journal of Catalysis 35, 1619-1640.

Lu, X., Carroll, K. J., Turvey, C. C. & Dipple, G. M. Rate and capacity of cation release from ultramafic mine tailings for carbon capture and storage. Applied Geochemistry 140, 105285 (2022).

Mac Dowell, N., Fennell, P. S., Shah, N. & Maitland, G. C. The role of CO 2 capture and utilization in mitigating climate change. Nature Climate Change 7, 243-249 (2017).

Mac Dowell, N., Reiner, D. M. & Haszeldine, R. S. Comparing Approaches for Carbon Dioxide Removal. Joule 6, 2233-2239 (2022).

Mattila, H.-P. & Zevenhoven, R. Mineral carbonation of phosphogypsum waste for production of useful carbonate and sulfate salts. Frontiers in Energy Research 3, 48 (2015).

Mendes G. d. O., Murta H. M., Valadares R. V., Silveira W. B. d., Silva I. R. d. and Costa M. D. (2020) Oxalic acid is more efficient than sulfuric acid for rock phosphate solubilization. Minerals Engineering 155, 106458.

Osman, A. I., Hefny, M., Abdel Maksoud, M., Elgarahy, A. M. & Rooney, D. W. Recent advances in carbon capture storage and utilisation technologies: a review. Environmental Chemistry Letters 19, 797-849 (2021).

Rau, G. H. et al. Direct electrolytic dissolution of silicate minerals for air CO2 mitigation and carbon-negative H2 production. Proceedings of the National Academy of Sciences 110, 10095-10100 (2013).

Rau, G. H., Willauer, H. D. & Ren, Z. J. The global potential for converting renewable electricity to negative-CO2-emissions hydrogen. Nature Climate Change 8, 621-625 (2018).

Riahi, K., R. Schaeffer, J. Arango, K. Calvin, C. Guivarch, T. Hasegawa, K. Jiang, E. Kriegler, R. Matthews, G. P. Peters, A. Rao, S. Robertson, A. M. Sebbit, J. Steinberger, M. Tavoni, D. P. van Vuuren. in IPCC, 2022: Climate Change 2022: Mitigation of Climate Change. Contribution of Working Group III to the Sixth Assessment Report of the Intergovernmental Panel on Climate Change (ed J. Skea P. R. Shukla, R. Slade, A. Al Khourdajie, R. van Diemen, D. McCollum, M. Pathak, S. Some, P. Vyas, R. Fradera, M. Belkacemi, A. Hasija, G. Lisboa, S. Luz, J. Malley,) (Cambridge University Press, 2022).

Ruiz-Agudo, E. et al. Experimental study of the replacement of calcite by calcium sulphates. Geochimica et Cosmochimica Acta 156, 75-93 (2015).

Sullivan, I. et al. Coupling electrochemical CO2 conversion with CO2 capture. Nature Catalysis 4, 952-958 (2021).

Zeman, F. Energy and material balance of CO2 capture from ambient air. Environmental science & technology 41, 7558-7563 (2007).

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112(f) or 35 U.S.C. § 112(6) is not invoked.

1. A method comprising:
reacting rock phosphorus with sulfuric acid (H₂SO₄) to produce phosphoric acid (H₃PO₄) and phosphogypsum (CaSO₄·nH₂O);
converting the phosphogypsum to a calcium-containing solid product and thereby generating an aqueous sulfate; and
electrolyzing the aqueous sulfate to produce hydrogen (H₂).

2. The method according to claim 1, further comprising synthesizing ammonia (NH₃) from the hydrogen.

3. The method according to claim 2, further comprising producing an ammonium salt from the ammonia.

4. The method according to claim 3, wherein the ammonium salt is an ammonium phosphate.

5. The method according to claim 4, wherein the method comprises producing the ammonium phosphate from the ammonia and the phosphoric acid.

6. The method according to claim 4, wherein the ammonium phosphate is selected from monoammonium phosphate (MAP), diammonium phosphate (DAP), and ammonium sulfate ((NH₄)₂SO₄).

7. The method according to claim 3, further comprising producing a fertilizer from the ammonium salt.

8. The method according to claim 1, wherein the method comprises a CO₂ sequestering protocol.

9. The method according to claim 8, wherein the CO₂ sequestering protocol comprises sequestering gaseous CO₂ via direct air capture (DAC).

10. The method according to claim 8, wherein the CO₂ sequestering protocol comprises reacting gaseous CO₂ with a base to produce an aqueous carbonate.

11. The method according to claim 10, wherein the method comprises reacting the aqueous carbonate with the phosphogypsum to produce the calcium-containing solid product.

12. The method according to claim 1, wherein the calcium-containing solid product comprises precipitated calcium carbonate (PCC) or a calcium hydroxide alkaline solid product.

13. An ammonium salt produced according to claim 3.

14. A calcium-containing solid product produced according to claim 1.

15. A system comprising:
a reactor configured to react rock phosphorus with sulfuric acid (H₂SO₄) to produce phosphoric acid (H₃PO₄) and phosphogypsum (CaSO₄·2H₂O);
a precipitator configured to convert the phosphogypsum to a calcium-containing solid product and thereby generate an aqueous sulfate; and
an electrolysis unit configured to electrolyze the aqueous sulfate to produce hydrogen (H₂).
